(19) United States
(12) Patent Application Publication
(10) Pub. No.: US 2018/0270208 A1
(43) Pub. Date: Sep. 20, 2018

(54) IMAGE PROCESSING APPARATUS AND IMAGE PROCESSING METHOD

(71) Applicant: SONY CORPORATION, TOKYO (JP)

(72) Inventors: KAZUHIKO TAKABAYASHI, TOKYO (JP); MITSUHIRO HIRABAYASHI, TOKYO (JP); YASUAKI YAMAGISHI, KANAGAWA (JP); TATSUYA IGARASHI, TOKYO (JP)

(21) Appl. No.: 15/761,739

(22) PCT Filed: Sep. 27, 2016
(86) PCT No.: PCT/JP2016/078351

§ 371 Date: Mar. 20, 2018

(30) Foreign Application Priority Data
Oct. 9, 2015 (JP) 2015-201189

(51) Int. Cl. H04L 29/06; H04N 21/2343; H04N 21/2347; H04N 21/235; H04N 21/2662; H04N 21/435; H04N 21/4405; H04N 21/6334; H04N 21/845; H04N 21/8543

(52) U.S. Cl. CPC H04L 63/0457; H04N 21/23439; H04N 21/23476; H04N 21/2353; H04N 21/8543; H04N 21/435; H04N 21/44055; H04N 21/6334; H04N 21/8456; H04N 21/2662

(57) ABSTRACT

The present disclosure relates to an image processing apparatus and an image processing method which enable reproduction of content data to be more reliably controlled. For example, with respect to a segment with which reproduction control for stream data obtained by encoding image data is carried out, a verification code of the stream data of the segment is produced, and the verification code produced is added to the stream data of the segment. In addition, for example, with respect to a segment with which reproduction control for stream data obtained by encoding image data is carried out, a verification code of the stream data of the segment is produced, the verification code produced and a verification code added to the stream data of the segment are compared with each other, and the reproduction of the stream data of the segment, a following segment, or both of them is controlled in response to agreement or disagreement between the verification codes. The present disclosure, for example, can be applied to an image producing apparatus, an image encoding apparatus, an image decoding apparatus or the like.

### TECHNICAL FIELD

The present disclosure relates to an image processing apparatus and an image processing method, and more particularly to an image processing apparatus and an image processing method which enable reproduction of content data to be more reliably controlled.

### BACKGROUND ART

In recent years, MPEG-DASH (Moving Picture Experts Group-Dynamic Adaptive Streaming over HTTP) has begun to spread as a foundation technique of a streaming service on the Internet (for example, refer to NPL 1).

In this MPEG-DASH, it is considered to prohibit/suppress a specific manipulation such as a trick play in a reproduction client for a specific “period” or “segment” (hereinafter referred to as a specific period). For example, there is considered a method of controlling the reproduction by utilizing a technical mechanism of DRM (Digital Rights Management).

### CITATION LIST

### Non Patent Literature

### [NPL 1]

MPEG-DASH (Dynamic Adaptive Streaming over HTTP) (URL: http://mpeg.chiariglione.org/standards/mpeg-dash/media-presentation-description-and-segment-formats/text-isoiec-23009-12012-dam-1) http://standards.iso.org/ittf/PubliclyAvailableStandards/c065274_IS0_IEC_23009-1_2014.zip

### SUMMARY

### Technical Problem

However, the past DRM technique is confined to the application of the reproduction rule regarding the period within the content including one file (for example, a file having an ISO base media file format). Thus, it is difficult that such a DRM technique is simply applied to MPEG-DASH with which a plurality of pieces of stream data can be combined to be reproduced as one piece of content, thereby carrying out the accurate reproduction control.

The present disclosure has been made in the light of such a situation, and enables the reproduction of the content data to be more reliably controlled.

### Solution to Problem

An image processing apparatus as a first aspect of the present technique is an image processing apparatus including a verification code producing portion and a verification code adding portion. In this case, the verification code producing portion produces, with respect to a segment with which reproduction control for stream data obtained by encoding image data is carried out, a verification code of the stream data of the segment. The verification code adding portion adds the verification code produced by the verification code producing portion to the stream data.

The verification code producing portion can produce a hash value by using key information used in encryption or decoding of the stream data of the segment for the stream data of the segment before being encrypted, and can make the hash value thus produced the verification code.

The image processing apparatus can further include an event message box producing portion. In this case, the event message box producing portion produces an event message box in which an event message is stored, and stores the verification code produced by the verification code producing portion in the event message box thus produced. The verification code adding portion can add the event message box having the verification code stored therein and produced by the event message box producing portion to the stream data.

The event message box producing portion can further store a DRM (Digital Rights Management) rule description with which content of the reproduction control is described as a rule of DRM in the event message box.

The image processing apparatus can further include a DRM (Digital Rights Management) rule description producing portion and a DRM rule description adding portion. In this case, the DRM rule description producing portion produces a DRM rule description with which content of the reproduction control is described as a rule of DRM. The DRM rule description adding portion adds the DRM rule description produced by the producing portion to the stream data.

The content of the reproduction control can contain prohibition of skip reproduction and prohibition period specification, specification of a period requiring reproduction in advance, prohibition of trick reproduction and prohibition period specification, prohibition of jump-in reproduction, prohibition period specification, and reproduction start position specification of the stream data.

The image processing apparatus can further include a common description producing portion and a common description adding portion. In this case, the common description producing portion produces a common description which is of a type independent of DRM (Digital Rights Management) exhibiting content of the reproduction control. The common description adding portion adds the common description produced by the common description producing portion to an MPD (Media Presentation Description) as control information regarding the reproduction of the stream data.

The content of the reproduction control can contain prohibition of skip reproduction and prohibition period specification, specification of a period requiring reproduction in advance, and prohibition of trick reproduction and prohibition period specification of the stream data.

Further, an image processing method as the first aspect of the present technique is an image processing method including: producing, with respect to a segment with which reproduction control for stream data obtained by encoding image data is carried out, a verification code of the stream data of the segment; and adding the verification code thus produced to the stream data.

An image processing apparatus as a second aspect of the present technique is an image processing apparatus including a production portion, a comparison portion, and a reproduction control portion. In this case, the production portion produces, with respect to a segment with which reproduction control for stream data obtained by encoding image data is carried out, a verification code of the stream data of the segment. The comparison portion compares the verification code produced by the production portion and a verification code added to the stream data with each other. The reproduction control portion controls the reproduction of the stream data of the segment, a following segment, or both of them in response to agreement or disagreement between the verification codes in the comparison by the comparison portion.

Further, an image processing method as the second aspect of the present technique is an image processing method including: producing, with respect to a segment with which reproduction control for stream data obtained by encoding image data is carried out, a verification code of the stream data of the segment; comparing the verification code thus produced and a verification code added to the stream data with each other; and controlling the reproduction of the stream data of the segment, a following segment, or both of them in response to agreement or disagreement between the verification codes.

An image processing apparatus as a third aspect of the present technique is an image processing apparatus including a production portion and an addition portion. In this case, the production portion produces, with respect to a segment with which reproduction control for stream data obtained by encoding image data is carried out, a DRM (Digital Rights Management) rule description in which content of the reproduction control is described as a rule of DRM. The addition portion adds the DRM rule description produced by the production portion to the stream data.

The content of the reproduction control can contain prohibition of skip reproduction and prohibition period specification, specification of a period requiring reproduction in advance, and prohibition of trick reproduction and prohibition period specification of the stream data.

The production portion can produce a segment playback control information box in which the DRM rule description is stored and information regarding the reproduction control of the segment is stored.

The production portion can produce a protection system specific header box in which the segment playback control information box is stored and information peculiar to the DRM is stored.

The image processing apparatus can further include a common description producing portion and a common description adding portion. In this case, the common description producing portion produces a common description which is of a type independent of the DRM exhibiting the content of the reproduction control. The common description adding portion adds the common description produced by the common description producing portion to an MPD (Media Presentation Description) as control information regarding reproduction of the stream data.

The content of the reproduction control can contain prohibition of skip reproduction and prohibition period specification, specification of a period requiring reproduction in advance, and prohibition of trick reproduction and prohibition period specification of the stream data.

Further, an image processing method as the third aspect of the present technique is an image processing method including: producing, with respect to a segment with which reproduction control for stream data obtained by encoding image data is carried out, a DRM (Digital Rights Management) rule description in which content of the reproduction control is described as a rule of DRM; and adding the DRM rule description thus produced to the stream data.

An image processing apparatus as a fourth aspect of the present technique is an image processing apparatus including an acquisition portion, decoding portion, and a reproduction control portion. In this case, the acquisition portion acquires a DRM (Digital Rights Management) rule description in which content of reproduction control is described as a rule of DRM and which is added to stream data obtained by encoding image data. The decoding portion decodes the stream data of an encrypted segment on the basis of the DRM rule description acquired by the acquisition portion. The reproduction control portion controls reproduction of the stream data of the segment decoded by the decoding portion.

Further, an image processing method as the fourth aspect of the present technique is an image processing method including: acquiring a DRM (Digital Rights Management) rule description in which content of reproduction control is described as a rule of DRM and which is added to stream data obtained by encoding image data; decoding the stream data of an encrypted segment on the basis of the DRM rule description acquired; and controlling reproduction of the stream data of the segment decoded.

In the image processing apparatus and image processing method as the first aspect of the present technique, with respect to the segment with which the reproduction control of the stream data obtained by encoding the image data is carried out, the verification code of the stream data of the segment concerned is produced, and the verification code thus produced is added to the stream data.

In the image processing apparatus and image processing method as the second aspect of the present technique, with respect to the segment with which the reproduction control of the stream data obtained by encoding the image data is carried out, the verification code of the stream data of the segment concerned is produced. The verification code thus produced and the verification code added to the stream data are compared with each other. The reproduction of the stream data of the segment concerned, the following segment, or both of them is controlled in response to the agreement or disagreement between the verification codes.

In the image processing apparatus and image processing method as the third aspect of the present technique, with respect to the segment with which the reproduction control of the stream data obtained by encoding the image data is carried out, the DRM (Digital Rights Management) rule description in which the content of the reproduction control is described as the rule of the DRM is produced, and the DRM rule description thus produced is added to the stream data.

In the image processing apparatus and image processing method as the fourth aspect of the present technique, the DRM (Digital Rights Management) rule description in which the content of the reproduction control is described as the rule of the DRM and which is added to the stream data obtained by encoding the image data is acquired. The stream data of the encrypted segment is decoded on the basis of the DRM rule description thus acquired. The reproduction of the stream data of the segment thus decoded is controlled.

### Advantageous Effect of Invention

According to the present disclosure, an image can be produced. In particular, reproduction of content data can be more reliably controlled.

### BRIEF DESCRIPTION OF DRAWINGS

FIG. 1 is a diagram depicting an example of a structure of an MPD.

FIG. 2 is a diagram explaining a hierarchical structure of the MPD.

FIG. 3 is a diagram explaining a hierarchical structure of the MPD.

FIG. 4 is a diagram explaining a hierarchical structure of the MPD.

FIG. 5 is a diagram depicting an example of a main configuration of a content reproducing system.

FIG. 6 is a diagram explaining an example of data to be delivered.

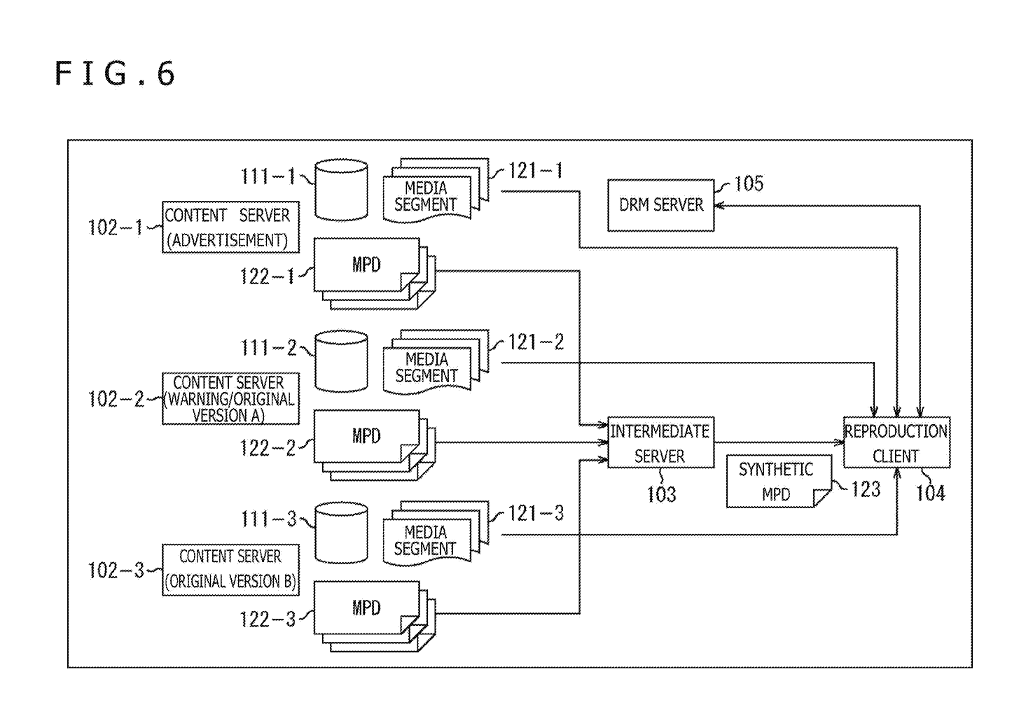

FIG. 7 is a diagram explaining an example of content data.

FIG. 8 is a diagram explaining an example of reproduction control for the content data.

FIG. 9 is a block diagram depicting an example of a main configuration of an authoring device.

FIG. 10 is a block diagram explaining an example of a main configuration of a media segment producing portion.

FIG. 11 is a diagram explaining an example of a main structure of an event message box.

FIG. 12 is a diagram explaining an example of a main description of the event message box.

FIG. 13 is a diagram depicting an example of a main description of a segment data auth code box.

FIG. 14 is a diagram explaining an example of a main structure of a protection system specific header box.

FIG. 15 is a diagram explaining an example of a main description of the protection system specific header box.

FIG. 16 is a diagram explaining an example of a main description of a segment playback control information box.

FIG. 17 is a diagram depicting an example of a main structure of a media segment.

FIG. 18 is a block diagram depicting an example of a main configuration of an MPD producing portion.

FIG. 19 is a block diagram depicting an example of a description of the MPD.

FIG. 20 is a flow chart explaining an example of a flow of media segment processing.

FIG. 21 is a flow chart explaining an example of a flow of event message box producing processing.

FIG. 22 is a flow chart explaining an example of a flow of MPD processing.

FIG. 23 is a block diagram depicting an example of a main configuration of a reproduction client.

FIG. 24 is a flow chart explaining an example of a flow of reproduction processing.

FIG. 25 is a flow chart explaining an example of a flow of media segment decoding processing.

FIG. 26 is a flow chart, following FIG. 25, explaining an example of a flow of the media segment decoding processing.

FIG. 27 is a diagram explaining an example of another structure of the event message box.

FIG. 28 is a diagram explaining an example of another description of the event message box.

FIG. 29 is a flow chart explaining another example of a flow of event message box producing processing.

FIG. 30 is a flow chart explaining an example of a flow of the media segment decoding processing.

FIG. 31 is a flow chart, following FIG. 30, explaining an example of a flow of the media segment decoding processing.

FIG. 32 is a block diagram depicting an example of a main configuration of a delivery system.

FIG. 33 is a block diagram depicting an example of a main configuration of a computer.

### DESCRIPTION OF EMBODIMENTS

Hereinafter, modes for carrying out the present disclosure (hereinafter referred to as embodiments) will be described. It should be noted that the description will be given in the following order.

1. First Embodiment (content reproducing system)

2. Second Embodiment (another example of event message box)

3. Third Embodiment (delivery system)

4. Fourth Embodiment (Computer)

### 1. First Embodiment

<Reproduction Control>

In recent years, MPEG-DASH (Moving Picture Experts Group-Dynamic Adaptive Streaming over HTTP) has begun to spread as a foundation technique of a streaming service on the Internet.

In this MPEG-DASH, it is considered to prohibit/suppress a specific manipulation such as a trick play in a reproduction client for a specific “period” or “segment” (hereinafter referred to as a specific period).

For example, there is considered a method in which a rule at the time of reproduction is described as an MPD (Media Presentation Description) used for content reproduction or another XML document, and a reproduction client follow the rule. Normally, however, the MPD is not protected against alteration or the like. Therefore, it is feared that the rule described in the MPD is modified. This also applies to the case of another XML document. It is possible to take the measures such as the anti-tamper or the like against these cases. However, in order to attain this, there is required the framework (sharing authentication information or a trust model between a service and a client, and so forth) which is approximately equal to that in a so-called DRM (Digital Rights Management). In addition, except for the case where the service side can control the reproduction client in any kind of way such as a contract, including the case where the anti-tamper is carried out, there is not a security in which the rule simply presented as “reproduction metadata” is abided on the reproduction client side.

In addition, for example, there is considered a method in which the time at which a next request becomes valid is described in “access token” used when each segment is requested for the server, and any of the requests at and before that time is rejected. “The access token” is generally utilized in order to authenticate presence or absence of an access right for a specific “content.” For example, it is considered to describe such time that “an access token,” for a next request, in which a segment in an “advertisement” period is acquired does not become valid unless the reproduction time period of the previous segment elapsed (it should be noted that the anti-tamper measures or the like are generally taken for “the access token” with a mechanism for each service). However, in case of this method, for securing the reproduction for a specific period, it is necessary to issue a “token” in which the deadline corresponding to a timing of a request in the previous period is described for a request for each period of individual clients. Thus, it is feared that the processing on the server side becomes complicated.

Incidentally, a part of the DRM techniques has a mechanism for prohibition/suppression of the specific manipulation in the client as the rule of the DRM. A method of controlling the reproduction by utilizing this DRM technique is considered. However, the past DRM technique is confined to the application of the reproduction rule regarding the period within the content including one file (for example, a file having an ISO base media file format). Thus, it is difficult that such a DRM technique is simply applied to MPEG-DASH with which a plurality of pieces of stream data can be combined to be reproduced as one piece of content to carry out the accurate reproduction control.

It should be noted that an advantage that such “a reproduction control rule” is operated as the DRM rule is as follows. Not only the reproduction can be more effectively controlled by utilizing the technical mechanism of the DRM, but also the behavior of the whole reproduction client (an apparatus or an application) in which the DRM function is incorporated can be enforced as a compliance rule associated with a license contract of the DRM technique.

<MPD>

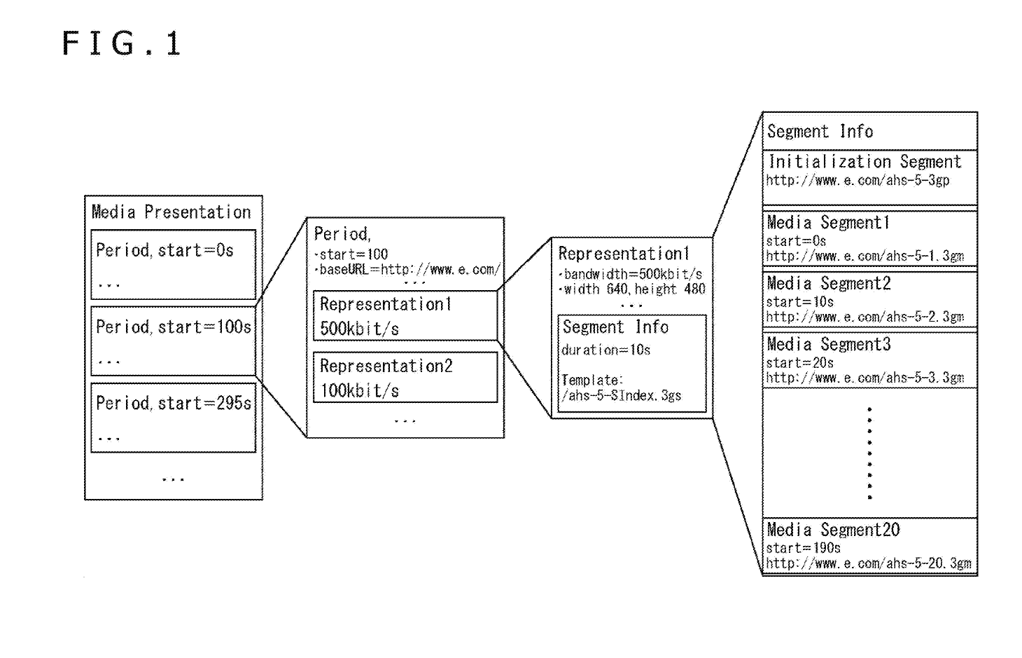

Firstly, a description will be given with respect to the MPD used in the reproduction in MPEG-DASH. The MPD, for example, has a structure as depicted in FIG. 1. In the analysis (parse) of the MPD, the reproduction client selects an optimal representation from attributes of representation included in a period of the MPD (Media Presentation of FIG. 1).

The reproduction client reads the head segment of the selected representation to acquire and process an initialization segment. Subsequently, the reproduction client acquires and reproduces the following segment.

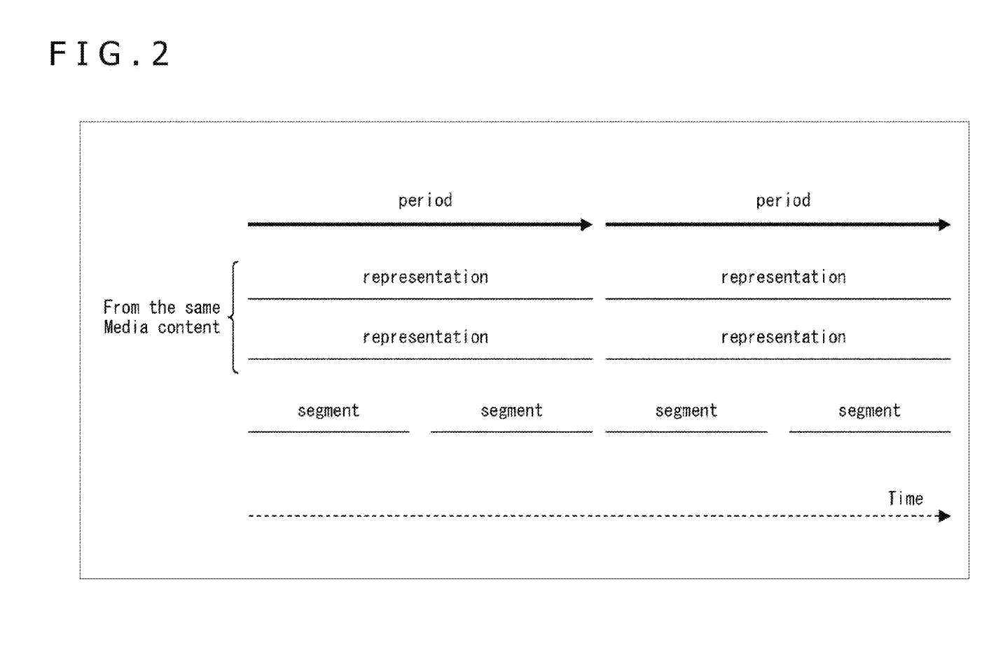

Incidentally, a relation among the period, the representation, and the segment in the MPD is as depicted in FIG. 2. In a word, one piece of media content can be managed for every period as a data unit in a temporal direction, and the periods can be managed for every segment as the data unit in the temporal direction. In addition, with respect to the periods, it is possible to structure a plurality of representations different in attribute such as a bit rate from one another.

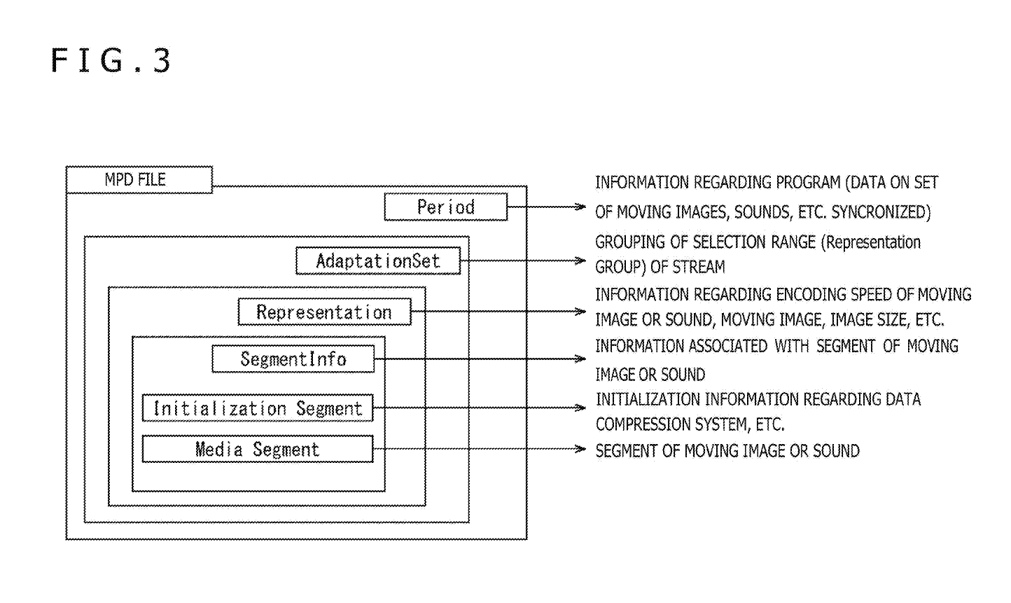

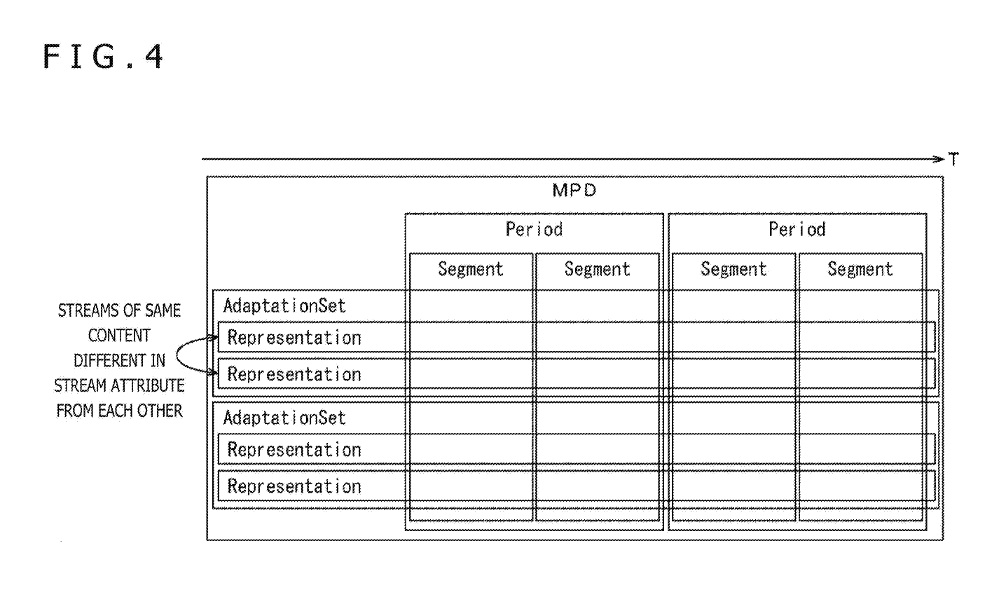

Therefore, a file of the MPD (referred to as an MPD file as well) has a hierarchical structure as depicted in FIG. 3 in and after the period. In addition, when the structures of the MPD are arranged side by side on the temporal axis, an example of FIG. 4 is obtained. As apparent from the example of FIG. 4, a plurality of representations are present for the same segment. The reproduction client can adaptively select any one of them, thereby acquiring and reproducing the suitable stream data in response to the communication environment, its decoding ability or the like.

<Content Reproducing System>

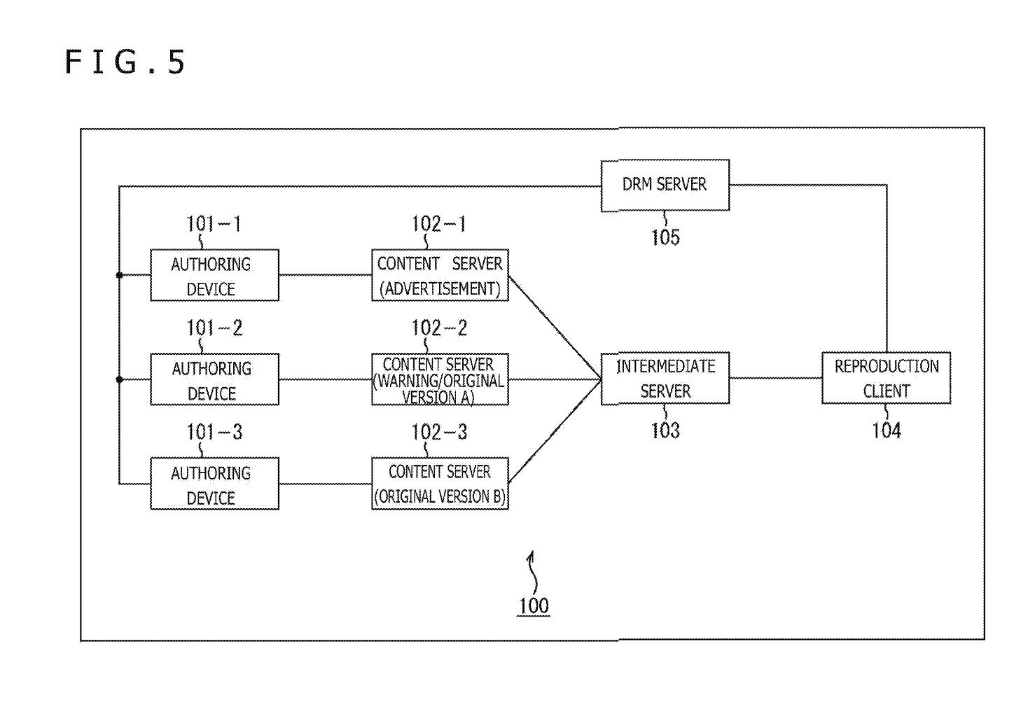

FIG. 5 is a block diagram depicting an example of a main configuration of a content reproducing system as an embodiment of an image processing system to which the present technique is applied. A content reproducing system 100 depicted in FIG. 5 is a system for carrying out streaming delivery or streaming reproduction of content including an image, a sound or the like (containing at least an image) by utilizing MPEG-DASH. The streaming means a method of successively reproducing the transmitted data, thereby carrying out the transmission and the reproduction in parallel to each other. The streaming delivery is a delivery method corresponding to such a streaming system, and the streaming reproduction is a reproduction method corresponding to such streaming reproduction.

The data of the content (content data) contains at least image data. The content data may contain other data such as audio data and control data. In a word, the content data may be so-called multi-media data. The content data, as described above, is streaming-delivered (streaming-reproduced). In a word, the content data is the data complying with the streaming system. Content data complying with such streaming system (for streaming delivery (reproduction)) is referred to as the stream data as well.

It should be noted that the content reproducing system 100 may carry out download delivery or download reproduction of the content. The download reproduction means a reproduction method of carrying out the reproduction after the transmission (download) of the whole data, and the download delivery means a delivery method corresponding to such download reproduction (in a word, a method of transmitting the whole data without taking the reproduction into consideration). In a word, the present technique can also be applied to a system for carrying out the download delivery or the download reproduction. It should be noted that the content data (for download delivery (reproduction)) complying with such a download system is referred to as download data as well.

Although in the following, a description will be given with respect to the case where the image data is encoded in the content data, the image data may be encoded or not may be encoded.

As depicted in FIG. 5, the content reproducing system 100 has an authoring device 101-1 to an authoring device 101-3, and a content server 102-1 to a content server 102-3.

The authoring device 101-1 to the authoring device 101-3 are each a device for producing the content data which is to be delivered and reproduced in the content reproducing system 100. In the following description, when the authoring device 101-1 to the authoring device 101-3 do not need to be distinguished from each other for the description, they are collectively referred to as the authoring device 101. The authoring device 101 produces the content data by utilizing the DRM technique presented by a DRM server 105 which will be described later. The authoring device 101-1 supplies the content data thus produced to the content server 102-1. The authoring device 101-2 supplies the content data thus produced to the content server 102-2. The authoring device 101-3 supplies the content data thus produced to the content server 102-3.

The content server 102-1 to the content server 102-3 each carry out the delivery (supply) of the content data. The content server 102-1 delivers the content data produced by the authoring device 101-1. For example, the content server 102-1 streaming-delivers the content data of “an advertisement.” The content server 102-2 delivers the content data produced by the authoring device 101-2. For example, the content server 102-2 streaming-delivers the content data of “warning” or “an original version A.” The content server 102-3 delivers the content data produced by the authoring device 101-3. For example, the content server 102-1 streaming-delivers the content data of “an original version B.” In the following description, when the content server 102-1 to the content server 102-3 do not need to be distinguished from each other for the description, they are collectively referred to as the content server 102.

It should be noted that although in FIG. 5, the three authoring devices 101 and the three content servers 102 are depicted, the content reproducing system 100 can have an arbitrary number of authoring devices 101 and an arbitrary number of content servers 102.

In addition, the content reproducing system 100 has an intermediate server 103, a reproduction client 104, and a DRM server 105.

The intermediate server 103 suitably combines pieces of the content delivered by the content server 102, and streaming-delivers the resulting content as new content.

The reproduction client 104 acquires the content data delivered by the intermediate server 103, and streaming-reproduces the content data thus acquired. In addition, the reproduction client 104 carries out the reproduction by utilizing the DRM technique presented by the DRM server 105 as may be necessary. It should be noted that the reproduction client 104 may be enabled to reproduce the content delivered by the content server 102.

The DRM server 105 presents the DRM technique to other devices (for example, the authoring device 101 and the reproduction client 104) of the content reproducing system 100. For example, the DRM server 105 presents arbitrary information for copyright protection or the like in terms of the DRM technique. For example, the DRM server 105 presents information used for the encryption/decoding of the data, the comparison/communication partner authentication of the data, and the like (for example, key information and the like). The DRM server 105 can present such a DRM technique for an arbitrary device.

In FIG. 5, one intermediate server 103, one reproduction client 104, and one DRM server 105 are depicted. However, the content reproducing system 100 can have an arbitrary number of intermediate servers 103, an arbitrary number of reproduction clients 104, and an arbitrary number of DRM servers 105.

<Content Data>

Next, a description will be given with respect to the content data which is delivered and reproduced in the content reproducing system 100. The content data includes a media segment and an MPD. The media segment is data in units of a segment containing image data (or multi-media data). In a word, the data to be reproduced is contained in the media segment (in other words, the media segment is the data to be reproduced). The MPD is control information (document) for controlling the reproduction of the media segment. The MPD is the data independent of the media segment, and with the MPD, the reproduction of an arbitrary number of media segments can be controlled. For example, by using the MPD, a plurality of media segments can be presented as one piece of content.

The content server 102-1 presents an arbitrary number of media segments 121-1 and an arbitrary number of MPDs 122-1 with which the reproduction of these media segments 121-1 is controlled in the form of the content data. In a word, the media segments 121-1 contain the image data of “the advertisement” (or the multi-media data). Then, the MPD 122-1 contains control information with which the image data of “the advertisement” (or the multi-media data) is reproduced. These pieces of content data are stored in a database 111-1 and managed therein. The database 111-1 may be built in the content server 102-1, or may be configured as a device different from the content server 102-1.

The content server 102-2 presents an arbitrary number of media segments 121-2 and an arbitrary number of MPDs 122-2 with which the reproduction of these media segments 121-2 is controlled in the form of the content data. In a word, the media segments 121-2 contain the image data of “the warning” or “the original version A” (or the multi-media data). Then, the MPD 122-2 contains control information with which the image data of “the warning” or “the original version A” (or the multi-media data) is reproduced. These pieces of content data are stored in a database 111-2 and managed therein. The database 111-2 may be built in the content server 102-2, or may be configured as a device different from the content server 102-2.

The content server 102-3 presents an arbitrary number of media segments 121-3 and an arbitrary number of MPDs 122-3 with which the reproduction of these media segments 121-3 is controlled in the form of the content data. In a word, the media segments 121-3 contain the image data of “the original version B” (or the multi-media data). Then, the MPD 122-3 contains control information with which the image data of “the original version B” (or the multi-media data) is reproduced. These pieces of content data are stored in a database 111-3 and managed therein. The database 111-3 may be built in the content server 102-3, or may be configured as a device different from the content server 102-3.

In the following description, when the database 111-1 to the database 111-3 do not need to be distinguished from one another for the description, they are collectively referred to as the database 111. In addition, when the media segment 121-1 to the media segment 121-3 do not need to be distinguished from one another for the description, they are collectively referred to as the media segment 121. Moreover, when the MPD 122-1 to the MPD 122-3 do not need to be distinguished from one another for the description, they are collectively referred to as the MPD 122.

The reproduction client 104 acquires and analyzes the MPD 122, acquires the media segment 121 corresponding to the description of the MPD 122, and reproduces the media segment 121 by using a method corresponding to the description of the MPD 122. In addition, when the reproduction client 104 acquires and reproduces the media segment 121, the reproduction client 104 acquires and utilizes information regarding the DRM from the DRM server 105 as may be necessary. For example, the reproduction client 104 acquires a decoding key from the DRM server 105, and decodes the encrypted data of the media segment 121 by using the decoding key.

The intermediate server 103 acquires the MPD 122 from the content server 102, and edits one or a plurality of MPDs 122 to produce a new MPD (synthetic MPD 123). In a word, the intermediate server 103 edits the existing content (MPD 122) to produce the synthetic MPD 123, and presents the synthetic MPD 123 as new content to the reproduction client 104. It should be noted that a user (manager or administrator) of the intermediate server 103 may be different from, or may be identical to, the user (manager or administrator) of the content server 102.

In addition, the intermediate server 103 processes only the data on the MPD 122, and does not process the media segment 121. In a word, when the reproduction client 104 carries out the reproduction on the basis of the synthetic MPD 123, the reproduction client 104 acquires the media segment 121 to be reproduced from the content server 102 (database 111). In this case as well, when the reproduction client 104 acquires and reproduces the media segment 121, the reproduction client 104 acquires the information regarding the DRM from the DRM server 105 and utilizes the information thus acquired as may be necessary.

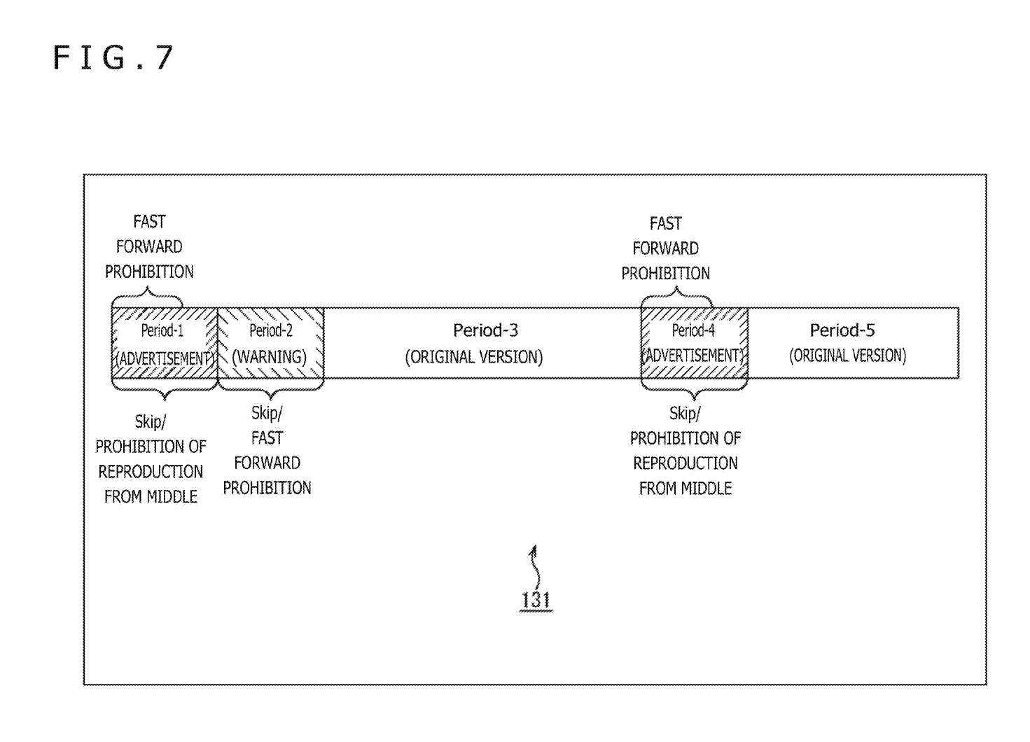

As described above, the intermediate server 103 edits the existing MPD 122 (for example, synthesizes a plurality of MPDs 122), thereby producing such an MPD (synthetic MPD 123) as to reproduce the media segment 121 as new content. For example, the intermediate server 103 produces such a synthetic MPD 123 as to reproduce the media segment 121 as such content as to be depicted in FIG. 7 from the MPDs 122 acquired from the content servers 102.

In FIG. 7, a direction from the left side to the right side in the figure is a direction of the time series. For example, in case of the normal reproduction in which the media segment 121 is reproduced at a predetermined speed previously determined (at a normal speed), the content 131 in an example of FIG. 7 is reproduced at the normal speed along the time series (in the direction from the left side to the right side in the figure). In a word, a period 1 (Period-1) including one or a plurality of media segments 121 of “the advertisement,” a period (Period-2) including one or a plurality of media segments 121 of “the warning,” a period 3 (Period-3) including one or a plurality of media segments 121 of “the original version A,” a period 4 (Period-4) including one or a plurality of media segments 121 of “the advertisement,” a period 5 (Period-5) including one or a plurality of media segments 121 of “the original version B” are successively reproduced.

Here, the period 1 (Period-1) is a period (range) in which the image of “the advertisement” is displayed. In a word, the period 1 (Period-1) is the period in which the media segment 121-1 of “the advertisement” is reproduced. In addition, the period 2 (Period-2) is a period (range) in which the image of “the warning” is displayed. In a word, the period 2 (Period-2) is the period in which the media segment 121-2 of “the warning” is reproduced. Moreover, the period 3 (Period-3) is a period (range) in which the image of “the original version A” is displayed. In a word, the period 3 (Period-3) is the period in which the media segment 121-2 of “the original version A” is reproduced. In addition, the period 4 (Period-4) is a period (range) in which the image of “the advertisement” is displayed. In a word, the period 4 (Period-4) is the period in which the media segment 121-1 of “the advertisement” is reproduced. Furthermore, the period 5 (Period-5) is a period (range) in which the image of “the original version B” is displayed. In a word, the period 5 (Period-5) is the period in which the media segment 121-3 of “the original version B” is reproduced.

<Reproduction Control>

Here, the period 1 (Period-1) and the period 4 (Period-4) of “the advertisement,” and the period 2 (Period-2) of “the warning” and the like are the periods which are desired to be viewed by a viewer of the content 131. Therefore, in these periods, like the example of FIG. 7, the reproduction control such as “fast forward prohibition,” “skip prohibition,” and “prohibition of reproduction from the middle” may be carried out.

Here, “the reproduction control” may be any control as long as it controls the reproduction method. For example, “the reproduction control” may also be control for prohibiting or suppressing the predetermined reproduction method (setting the reproduction method for the prohibition or the suppression). In other words, the reproduction control may also be one for permitting or recommending a predetermined reproduction method (setting a reproduction method for the permission or the recommendation). Although this predetermined reproduction method is arbitrary, for example, this predetermined reproduction method may be a reproduction method other than the normal reproduction in which the data is reproduced at a predetermined speed in the order of the time series.

For example, the reproduction control may be one for prohibiting the fast forward reproduction in which the reproduction is carried out at a higher speed than that in the normal reproduction, the rewind reproduction (reverse reproduction) in which the reproduction is carried out in a direction reverse to the time series, the slow reproduction in which the reproduction is carried out at a lower speed than that in the normal reproduction, or a so-called trick play such as the momentary pause (referred to as the trick reproduction as well) (No Trick Play). It should be noted that, for example, like “No Fast Forward,” “No Rewind,” “No Fast Rewind,” “No Slow Forward,” “No Slow Reverse” and the like, the reproduction methods of the trick play may be individually controlled (for example, prohibited).

In addition, for example, the reproduction control may be one for prohibiting the skip reproduction in which the reproduction is carried out so as to skip a partial period (range) (No Skip). Moreover, for example, the reproduction control may be one for specifying the period (range) requiring the reproduction in advance than the period (range) concerned (Only After). In addition, for example, the reproduction control may be one for prohibiting the jump-in reproduction in which the reproduction is started in the middle of the predetermined period (range) (No Jump-In). For example, when the reproduction is instructed to be started in the middle of the set period (random access), the control is carried out in such a way that the reproduction is started at the head of the period concerned, or in a specific position in the outside of the period.

Moreover, for example, all the control associated with the reproduction control concerned such as the specification of the period (range) to be controlled, the specification of the reproduction start position (jump destination), the specification of permission or prohibition, and the specification of the parameter may be contained in this reproduction control.

In addition, the reproduction control may contain the control associated with the display of the reproduced image such as the color and the image size, may contain the control associated with a computer graphic image (for example, caption or the like) superimposed on the image, or may contain the control associated with the sound or the like other than the image. Of course, the number of items to be controlled is arbitrary, and thus a plurality of items of the items described above (of course, may contain the items not described above) may be controlled.

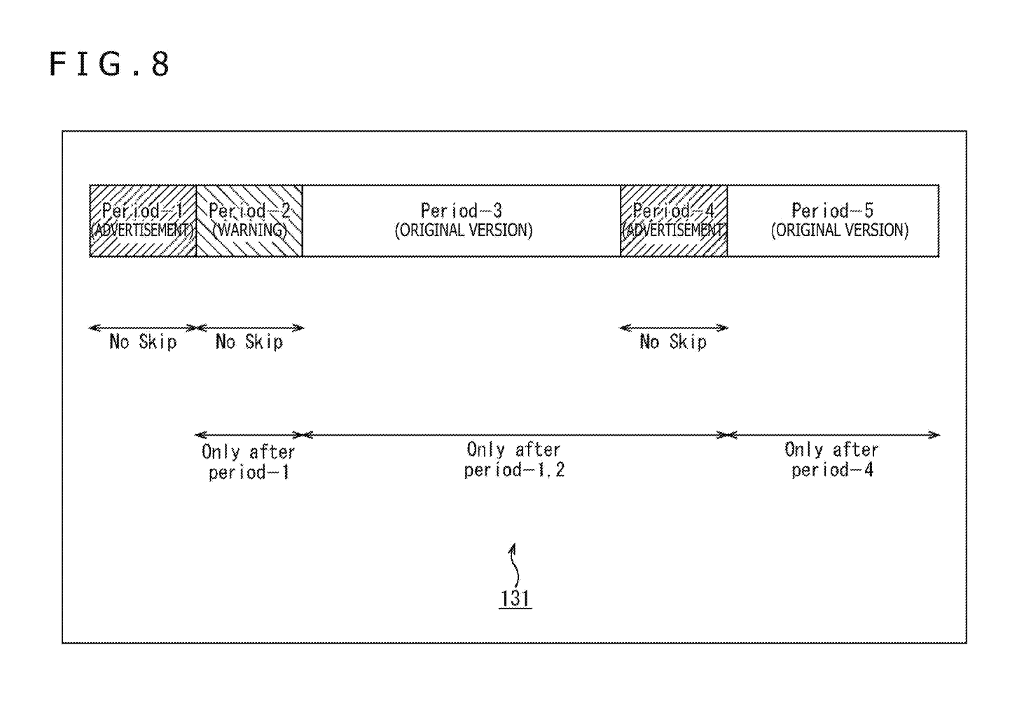

When the reproduction control like FIG. 7 is carried out, for example, like FIG. 8, it is only necessary that the prohibition of the trick play (No Trick) and the prohibition of the skip reproduction (No Skip) are carried out for the period 1 (Period-1), the period 2 (Period-2), and the period 4 (Period-4). In addition, as far as the control for Only after, it is only necessary that the period 1 (Period-1) is specified for the period 2 (Period-2), the period 1 (Period-1) and the period 2 (Period-2) are specified for the period 3 (Period-3) and the period 4 (Period-4), and the period 4 (Period-4) is specified for the period 5 (Period-5).

Such reproduction control is carried out on the basis of the request made from the data delivery side. The data reproduction side carries out the reproduction in accordance with the reproduction control. For example, in case of the content reproducing system 100 of FIG. 5, such reproduction control is set by the authoring device 101 or the intermediate server 103. For example, when the authoring device 101 carries out the reproduction control, the authoring device 101 sets the information regarding the reproduction control in the media segment 121, the MPD 122, or both of them produced by the authoring device 101 itself. In addition, for example, when the intermediate server 103 carries out the reproduction control, the intermediate server 103 sets the information regarding the reproduction control in the synthetic MPD 123 produced by the intermediate server 103 itself. It should be noted that the content server 102 may set the information regarding the reproduction control in the media segment 121, the MPD 122, or both of them produced by the authoring device 101. In addition, the information regarding the reproduction control may be set by other device not depicted in FIG. 5.

Hereinafter, a description will be given with respect to the case where the authoring device 101 carries out the reproduction control, and the case where the intermediate server 103 carries out the reproduction control. Firstly, a description will be given with respect to the case where the authoring device 101 carries out the reproduction control.

<Authoring Device>

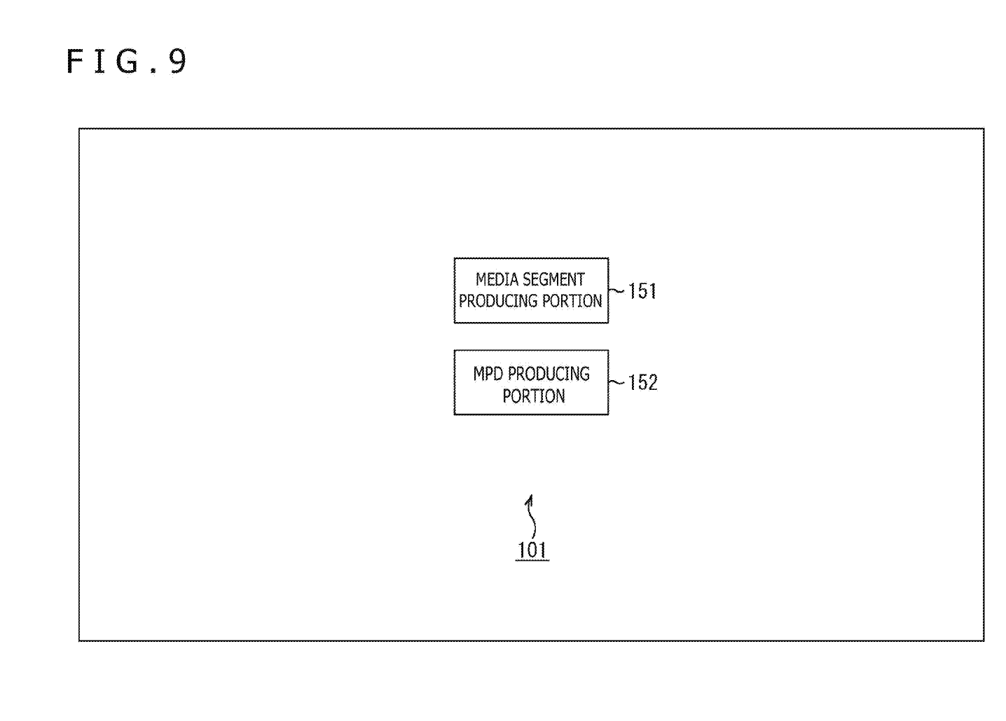

FIG. 9 is a block diagram depicting an example of a main configuration of the authoring device 101. The authoring device 101 can produce the content data (the media segment 121, the MPD 122, or both of them) delivered by the content server 102. Then, the authoring device 101, for example, as depicted in FIG. 9, has a media segment producing portion 151 and an MPD producing portion 152.

The media segment producing portion 151 executes processing regarding the production of the media segment 121. In addition, the MPD producing portion 152 executes processing regarding the production of the MPD 122. It should be noted that when the authoring device 101 produces only the media segment 121 as the content data, the MPD producing portion 152 may be omitted. In addition, when the authoring device 101 produces only the MPD 122 as the content data, the media segment producing portion 151 may be omitted.

<Media Segment Producing Portion>

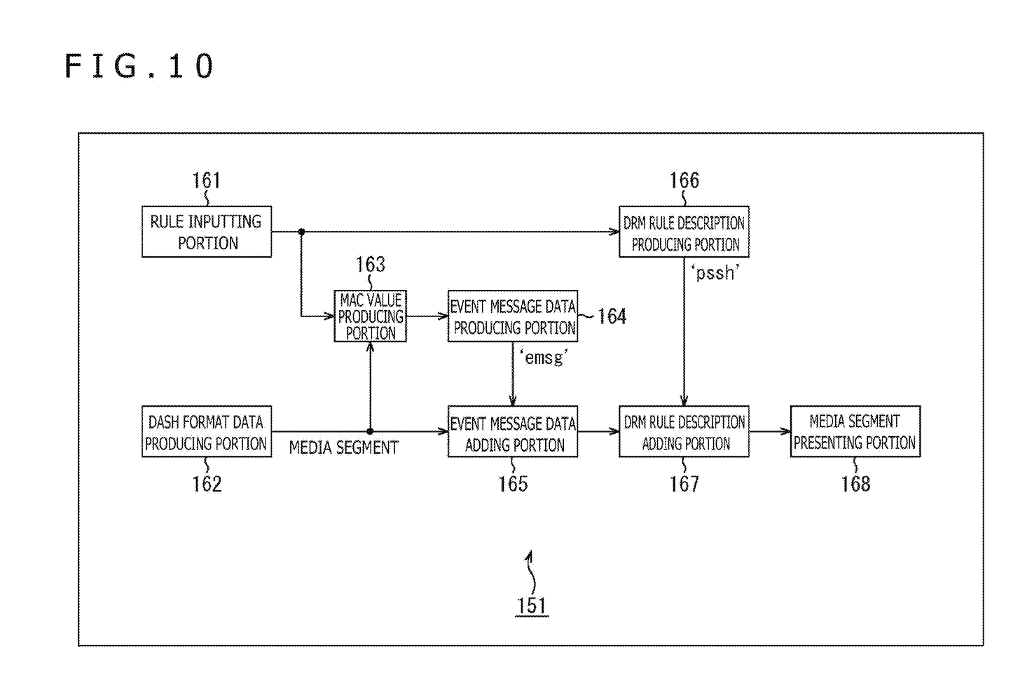

FIG. 10 is a block diagram depicting an example of a main configuration of the media segment producing portion 151. As depicted in FIG. 10, the media segment producing portion 151 has a rule inputting portion 161, a DASH format data producing portion 162, a MAC (Message Authentication Code) value producing portion 163, and an event message data producing portion 164. In addition, the media segment producing portion 151 has an event message data adding portion 165, a DRM rule description producing portion 166, a DRM rule description adding portion 167, and a media segment presenting portion 168.

The rule inputting portion 161 acquires the information (reproduction rule) regarding the reproduction control from the outside. An acquisition source of the representation rule is arbitrary. For example, the reproduction rule inputted by the user may be received by a user interface (UI) of software or a file in which the reproduction rule is described may be read. The reproduction rule may be any type of data. For example, the type of reproduction rule may be an XML file in which the reproduction rule is described with XML. The rule inputting portion 161 supplies the reproduction rule thus acquired to the MAC value producing portion 163 and the DRM rule description producing portion 166.

The DASH format data producing portion 162 executes processing regarding the production of the media segment 121. The DASH format data producing portion 162 supplies the media segment 121 thus produced to the MAC value producing portion 163 and the event message data adding portion 165.

The MAC value producing portion 163 is an embodiment of a verification code producing portion for producing a verification code of the media segment 121. The MAC value producing portion 163 produces the verification code (MAC value) of the media segment 121, with which the reproduction control is carried out, in accordance with the reproduction rule supplied from the rule inputting portion 161. The MAC value producing portion 163 supplies the MAC value thus produced to the event message data producing portion 164.

The event message data producing portion 164 produces an event message box (‘emsg’ box) in which a dynamic event message is to be stored with MPEG-DASH, and stores the verification code (MAC value) produced by the MAC value producing portion 163 in the event message box thus produced. After the event message data producing portion 164 produces the event message box (‘emsg’ box) 171 as described above, the event message data producing portion 164 supplies the event message box (‘emsg’ box) 171 to the event message data adding portion 165.

The event message data adding portion 165 is an embodiment of a verification code adding portion for adding the verification code (MAC value) produced by the verification code producing portion (for example, the MAC value producing portion 163) to the stream data. The event message data adding portion 165 adds the event message box (‘emsg’ box) 171 (containing the MAC value) supplied from the MAC value producing portion 163 through the event message data producing portion 164 to a predetermined position of the media segment 121 produced by the DASH format data producing portion 162. The event message data adding portion 165 supplies the media segment 121 to which the event message box (‘emsg’ box) 171 is added to the DRM rule description adding portion 167.

The DRM rule description producing portion 166 is an embodiment of a production portion for producing the DRM rule description with which the content of the reproduction control is described as the rule of the DRM with respect to the segment with which the reproduction control for the stream data having image data encoded is carried out. The DRM rule description producing portion 166 produces the DRM rule description with which the content of the reproduction control is described as the rule of the DRM in accordance with the reproduction rule supplied from the rule inputting portion 161. The DRM rule description producing portion 166 supplies the DRM rule description thus produced to the DRM rule description adding portion 167.

The DRM rule description adding portion 167 adds the DRM rule description supplied from the DRM rule description producing portion 166 to a predetermined position of the media segment 121 produced by the DASH format data producing portion 162. The DRM rule description adding portion 167 supplies the media segment 121 to which the DRM rule description is added to the media segment presenting portion 168.

The media segment presenting portion 168 supplies the media segment supplied thereto to the content server 102.

<MAC Value>

Next, a description will be given with respect to the verification code (MAC value) produced by the MAC value producing portion 163. The verification code (MAC value) may be any type of information as long as it can verify that the proper data is acquired and is decoded when the media segment 121 is reproduced. For example, the MAC value producing portion 163 may hash-calculate the media segment 121 of the object of the reproduction control (the encoded data of the image data or the multi-media data contained in the media segment 121), and may make the resulting hash value the verification code (MAC value). In this case, the MAC value producing portion 163 may obtain the hash value (that is, the MAC value) of the media segment 121 (the encoded data before the encryption (clear text)) of the object of the reproduction control by, for example, using the key information (encryption key or decoding key) used in the encryption or the decoding of the media segment 121 (encoded data) as the object of the reproduction control. The key information, for example, may be supplied from the DRM server 105.

It should be noted that the MAC value producing portion 163 may produce the verification code (MAC value) for every unit of the data other than the segment. In a word, the MAC value producing portion 163 can produce the verification code (MAC value) every arbitrary unit of data. For example, the data unit may be the period unit, the representation unit, the frame unit, the unit of the block (partial area) within the frame, or the data unit other than these data units.

<Event Message Box>

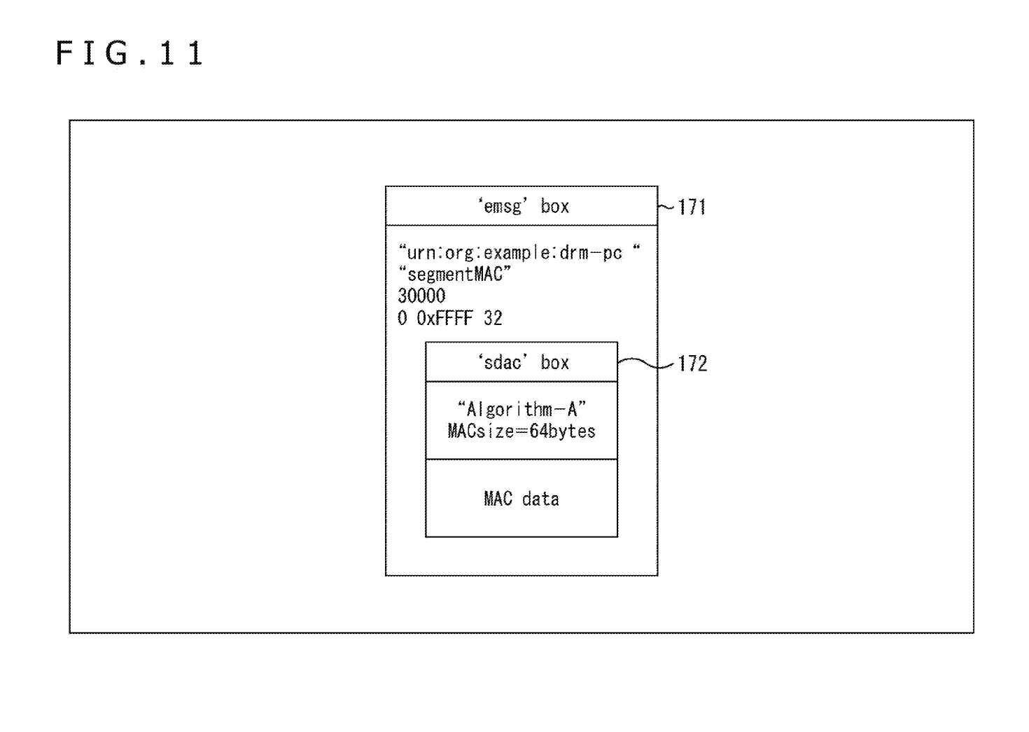

Next, a description will be given with respect to the event message box (‘emsg’ box) produced by the event message data producing portion 164. For example, the event message data producing portion 164, as depicted in FIG. 11, produces the event message box (‘emsg’ box) 171, and further produces the segment data auth code box (‘sdac’ box) 172. Then, the event message data producing portion 164 stores the information regarding the MAC value in the produced segment data auth code box (‘sdac’ box) 172, and stores the segment data auth code box (‘sdac’ box) 172 on the event message box (‘emsg’ box) 171.

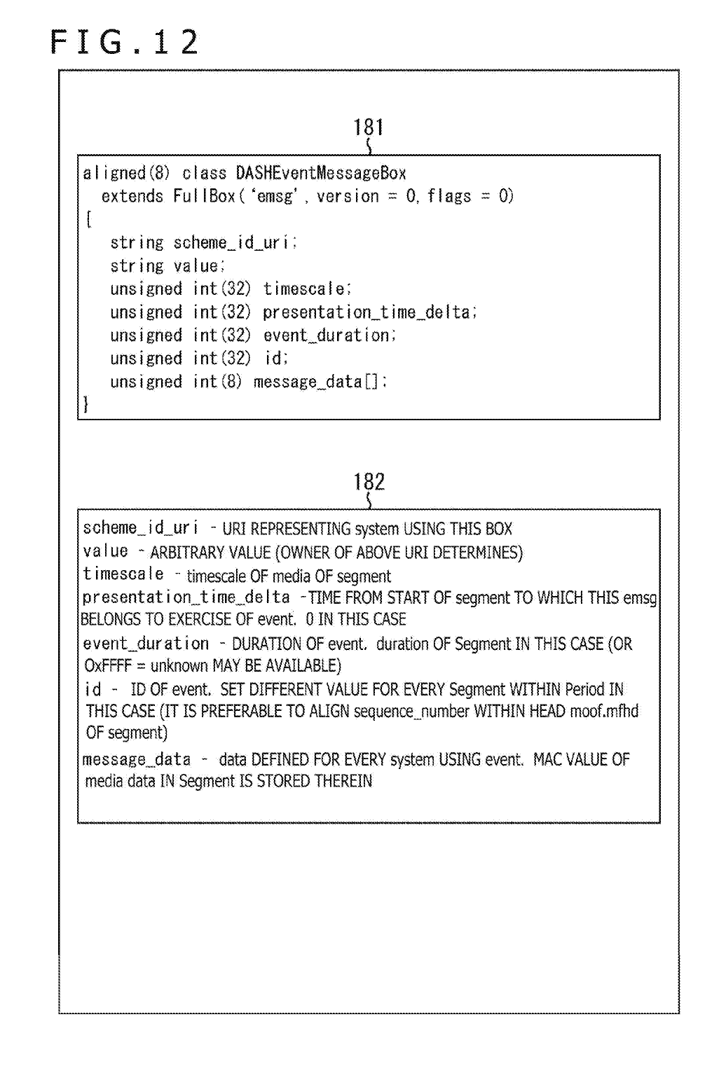

An example (description example) of syntax of the event message box (‘emsg’ box) 171 is represented in syntax 181 of FIG. 12. In addition, an example of semantics (semantics of the event message box (‘emsg’ box) 171) of the parameters used in the syntax 181 is represented in semantics 182 of FIG. 12. As represented in the semantics 182, the MAC value (that is, the segment data auth code box (‘sdac’ box) 172) is stored in “message_data[].”

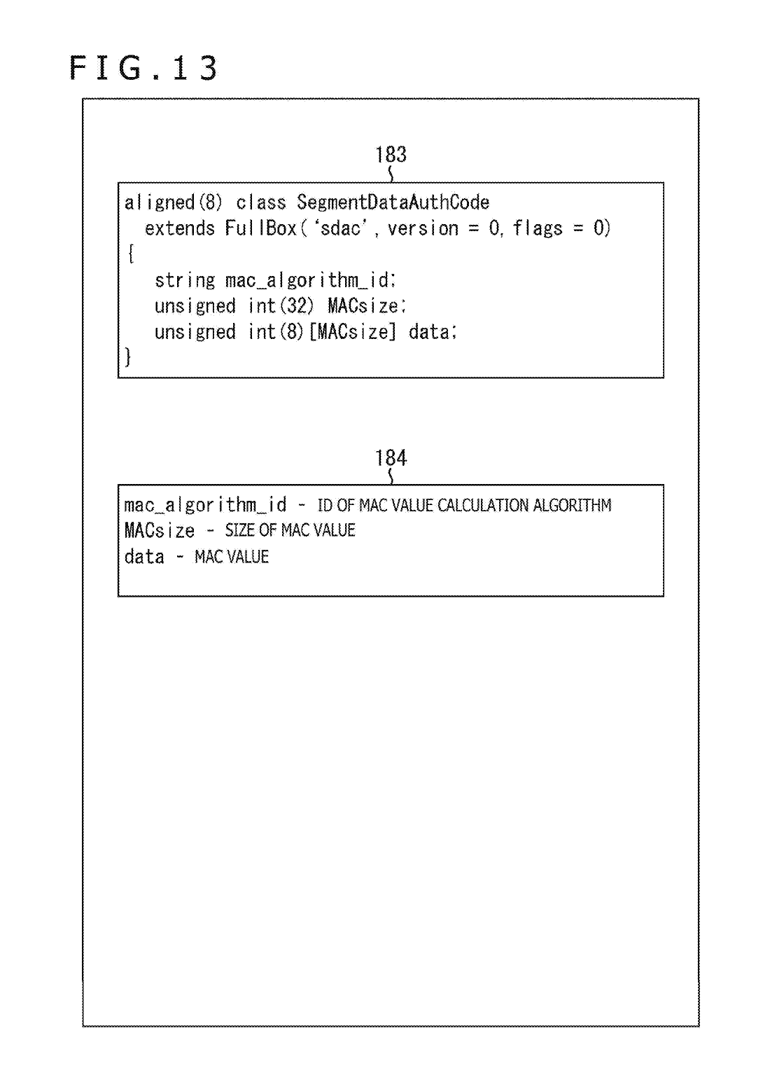

An example (description example) of the syntax of the segment data auth code box (‘sdac’ box) 172 is represented in syntax 183 of FIG. 13. In addition, an example of the semantics (the semantics of the segment data auth code box (‘sdac’ box) 172) of parameters used in the syntax 183 is represented in semantics 184 of FIG. 13. As represented in the semantics 184, in the segment data auth code box (‘sdac’ box) 172, as the information regarding the MAC value, the MAC value is stored as “data,” the size of the MAC value is stored as “MACsize,” and ID of the MAC value calculation algorithm is stored as “mac algorithm_id.”

It should be noted that the event message data adding portion 165 can add the event message box (‘emsg’ box) 171 (containing the MAC value) to the media segment 121 of an arbitrary segment. In a word, the event message data adding portion 165 can add the MAC value to the media segment 121 of the segment corresponding to the MAC value concerned, or can add the MAC value to the media segment 121 of other segment.

As described above, the verification code is produced and is added to the media segment 121, whereby during the reproduction of the media segment 121, the reproduction client 104 verifies whether or not the data of the processing object is the proper data by using the verification code. Only when the data is the proper data, the data can be reproduced. In other words, the data delivery side (the authoring device 101 or the content server 102 in case of the content reproducing system 100 of FIG. 5) can define “the proper data” at a predetermined reproduction timing. In a word, the data delivery side can control the order of the data reproduction.

For example, in case of the independent content like a DVD, it is easy to control the reproduction side by providing the reproduction rule by using the control information or the like. On the other hand, in case of MPEG-DASH, the content is formed by combining a plurality of media segments with one another. Then, the combination can be freely set by the MPD or the like. In other words, since the MPD can be changed in the reproduction client 104, even if the reproduction rule is simply described in the MPD, it is not guaranteed that the reproduction client 104 abides that rule. Even if the reproduction client 104 does not alter (change) the MPD, it is also possible that when the intermediate server 103 produces the synthetic MPD 123, the intermediate server 103 does not take over the reproduction rule produced by the authoring device 101 from the MPD 122. For example, when a manager (administrator) of the intermediate server 103 and a manager (administrator) of the content server 102 (authoring device 101) are different from each other, there is the possibility that the manager (administrator) of the intermediate server 103 uniquely sets the reproduction rule. In such a way, with the method in which the reproduction rule is simply defined only by the MPD, it is feared that the possibility of the realization of the desired reproduction control is reduced.

On the other hand, by using the verification data, as described above, for example, the authoring device 101 (content server 102) can specify the segment with which the verification data necessary for the reproduction of the stream data of a certain segment is obtained. In a word, the authoring device 101 (content server 102) can control the order of the reproduction of the segments.

For example, the authoring device 101 (content server 102) sets the verification data, whereby the reproduction client 104 can reproduce segments in order along the time series (only the normal reproduction can be permitted). At this time, for example, when the reproduction client 104 carries out the fast forward reproduction, the rewind reproduction, the skip reproduction, or the like, the proper verification code cannot be obtained because the reproduction of part of the data is omitted. Therefore, the comparison of the verification codes fails, and thus the reproduction fails.

In such a way, the authoring device 101 (content server 102) can more reliably realize the desired reproduction control (can more reliably control the reproduction of the content data).

It should be noted that with this control method using the verification code, strictly, it is possible to guarantee that carrying out the acquisition of the data, the decoding of the encrypted data, or the like is controlled, but it is impossible to guarantee that “the reproduction” of the data is controlled. In a word, even if the data is not actually reproduced, the reproduction client 104 can obtain the verification code. However, from a viewpoint of the addition of processing, the processing time period, and the like, carrying out the acquisition and decoding of the stream data is approximately equal to reproducing the data. Even if the reproduction of the data is omitted, the merit which is obtained in the reproduction client 104 is very small, rather, the demerit in which the unnecessary processing will be executed is large. Therefore, it can be said that such reproduction control substantially controls the reproduction. It should be noted that the control is carried out in such a way that the delivery timing of the stream data is made closer to the reproduction timing, thereby enabling the reliability of the reproduction control to be more increased. For example, when only the normal reproduction is permitted, the delivery timing is made close to the reproduction timing of the normal reproduction, thereby enabling other reproductions (such as the trick reproduction and the skip reproduction) to be made more difficult to carry out.

It should be noted that although such reproduction control is generally carried out in a closed manner within the period, it, of course, may succeed between the periods. In addition, the reproduction control, of course, may be carried out for a partial period within the segment (that is, the verification codes are allocated). In other words, the segment can be partitioned into a plurality of periods, so that the reproduction control can be carried out with respect to each of the periods (the respective verification codes are allocated thereto).

Incidentally, for producing the verification code (MAC value), by utilizing the key information regarding the DRM, the reproduction client 104 can readily and safely acquire the key information. Therefore, the comparison of the verification codes can be more readily and safely carried out.

<DRM Rule Description>

Next, a description will be given with respect to the DRM rule description produced by the DRM rule description producing portion 166. The DRM rule description producing portion 166 produces the rule description peculiar to the DRM (DRM rule description) utilized in accordance with the reproduction rule, and stores the DRM rule description in a protection system specific header box (‘pssh’ box) which is used to insert the DRM peculiar information with Common Encryption.

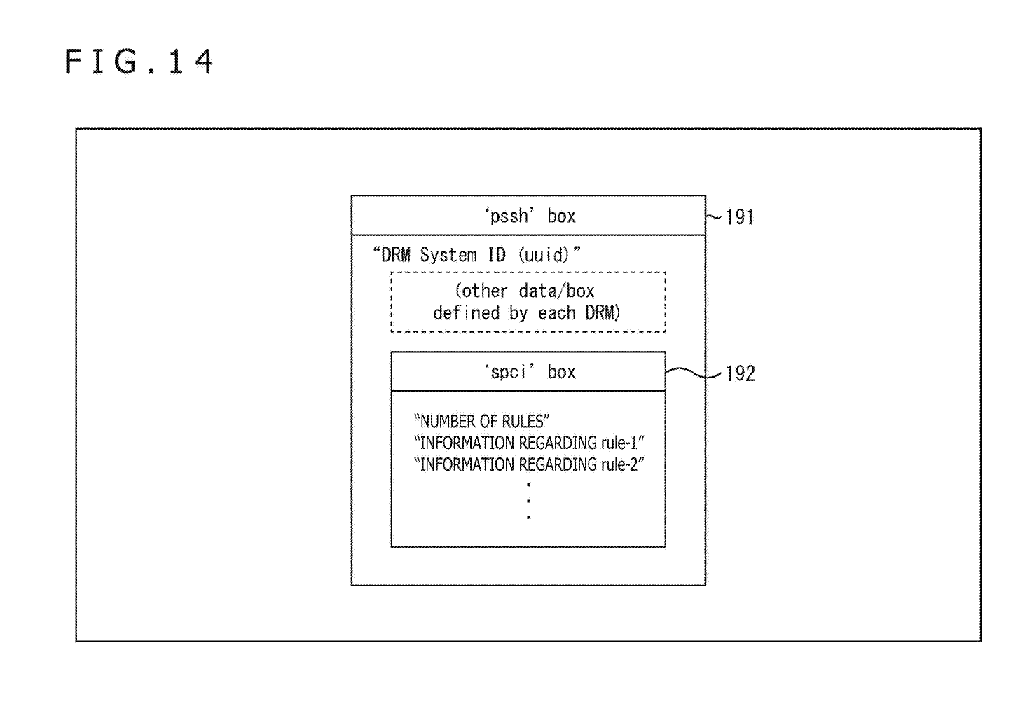

For example, the DRM rule description producing portion 166, as depicted in FIG. 14, produces the protection system specific header box (‘pssh’ box) 191, and further produces a segment playback control information box (‘spci’ box) 192. Then, the DRM rule description producing portion 166 stores the DRM rule description in the segment playback control information box (‘spci’ box) 192 thus produced, and stores that the segment playback control information box (‘spci’ box) 192 in the protection system specific header box (‘pssh’ box) 191.

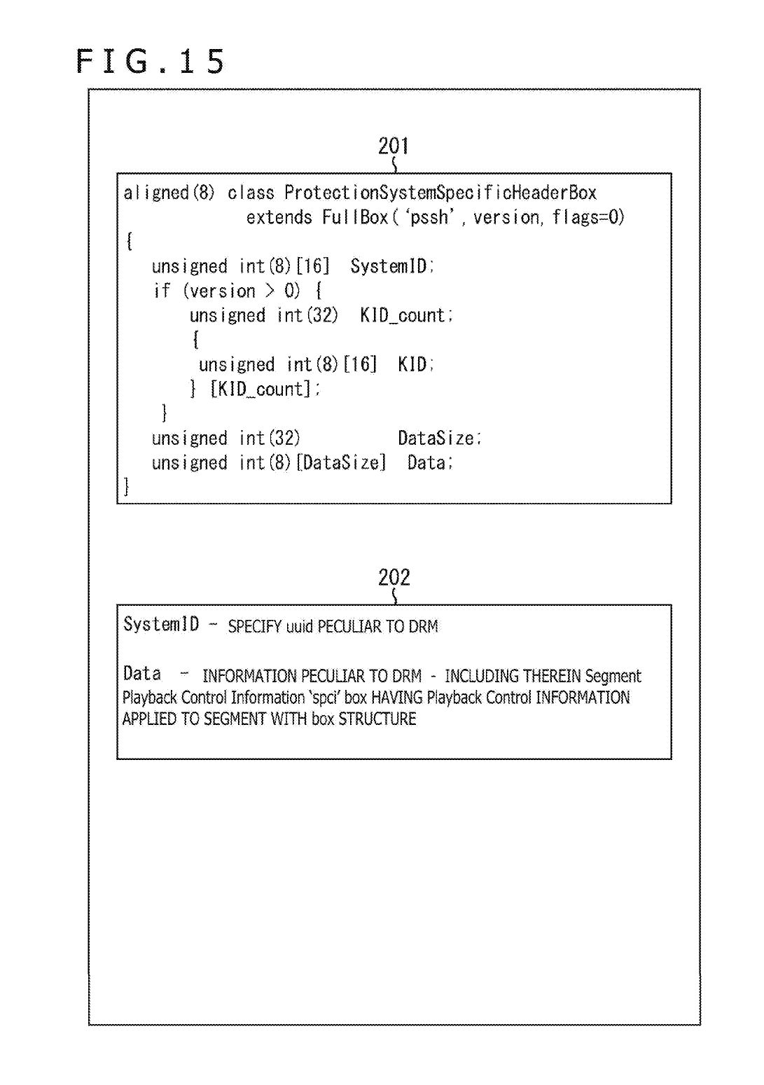

An example (description example) of syntax of the protection system specific header box (‘pssh’ box) 191 is represented in syntax 201 of FIG. 15. In addition, an example of semantics (semantics of the protection system specific header box (‘pssh’ box) 191) of parameters used in the syntax 201 is represented in semantics 202 of FIG. 15. As represented in the semantics 202, for example, the information peculiar to the DRM containing the segment playback control information box (‘spci’ box) 192 is stored in “Data.”

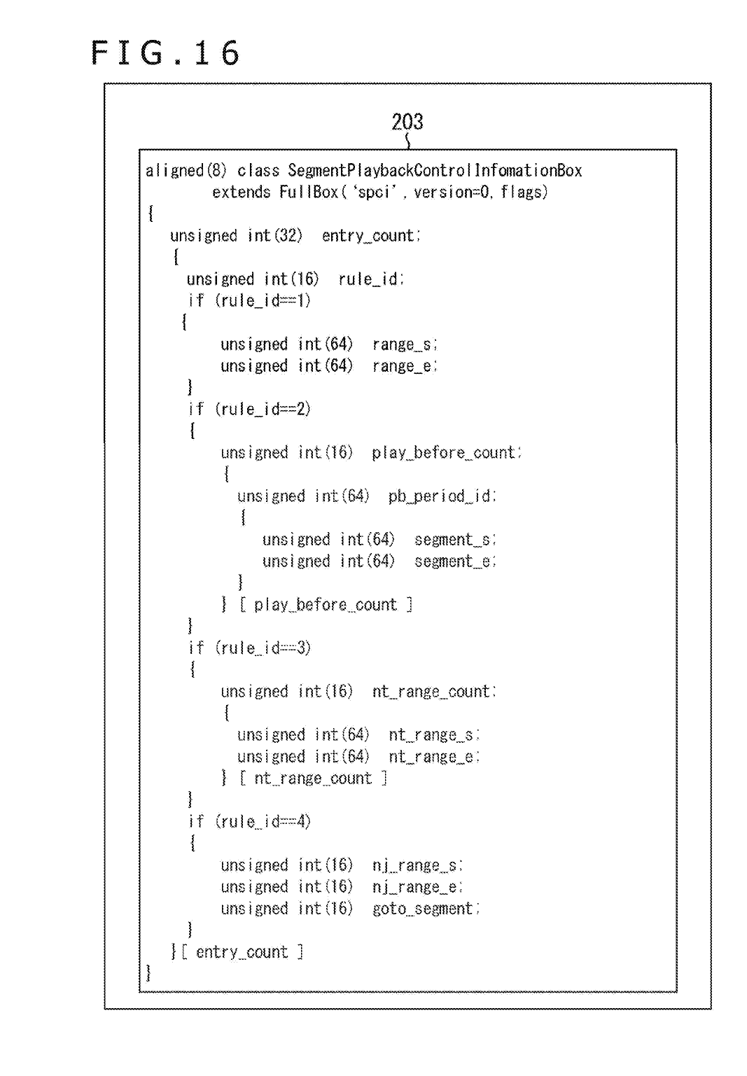

An example (description example) of syntax of the segment playback control information box (‘spci’ box) 192 is represented in syntax 203 of FIG. 16. Incidentally, in the syntax 203, the semantics of the parameters, for example, is described as follows.

rule_id: applied rule identifier

1: No skip

2: Only After

3: No Trick Play

4: No Jump-In

range_s, range_e: start/end sample numbers to which No skip is applied within movie fragment

play_before count: the number of Periods becoming an object of Only After

pb_period_id: identifier of periods becoming an object of Only after

Pb_segment_s, pb_segment_e: object segment start/end movie fragment numbers within a Period as an object of Only after

nt_range_count: the number of ranges becoming an object of No Skip within a segment (movie fragment)

nt_range_s, nt_range_e: start/end sample numbers of No Trick Play object range

nj_range_s, nj_range_e: start/end sample numbers of No Jump-In object range

goto_segment: a movie fragment number to start reproduction when Jump_In is carried out

The DRM rule description adding portion 167 adds the protection system specific header box (‘pssh’ box) 191 in which the DRM rule description as described above is stored to the media segment 121. It should be noted that the DRM rule description adding portion 167 can add the protection system specific header box (‘pssh’ box) 191 having an arbitrary segment to the media segment 121 having an arbitrary segment. In addition, although in FIG. 16, the reproduction rules are defined with respect to four reproduction methods, the reproduction method with which the reproduction control can be carried out is arbitrary and is by no means limited to this example. For example, in this DRM rule description, the control for the various kinds of reproduction methods as described with reference to FIG. 7 and FIG. 8 can be defined.

As depicted in FIG. 16, the details of the reproduction methods (adaption period (range) specification, jump destination specification, etc.) can be set as the DRM rule description. Therefore, not only the more various reproduction controls can be realized, but also the more detailed control within the segment can be realized. It should be noted that since the DRM rule description is used together with the event message data described above (verification data (MAC value)), thereby enabling the verification of the data to be reproduced to be carried out. Therefore, as compared with the case of only the reproduction control using the DRM rule description, the reproduction of the content data can be more reliably controlled. In other words, as compared with the case of only the reproduction control using the verification data (MAC value) described above, it is possible to realize the more various and detailed reproduction control.

<Media Segment>

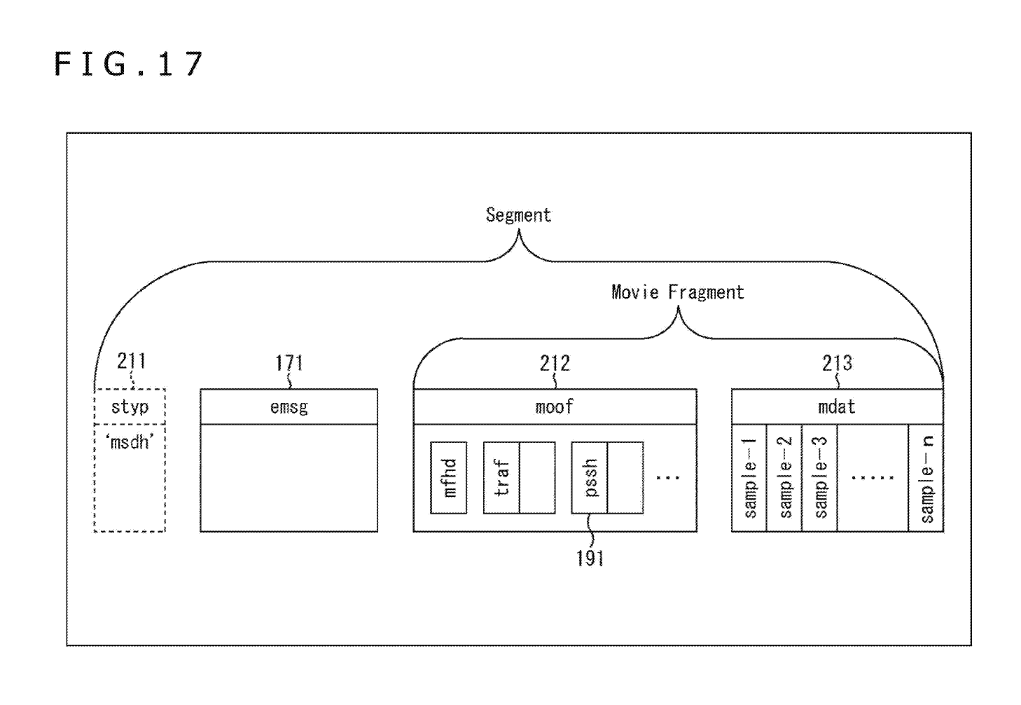

As described above, the media segment 121 to which the event message data and the DRM rule description are added, for example, has a structure as depicted in FIG. 17. As depicted in FIG. 17, the segment has a segment type box (‘styp’) 211, and a movie fragment including a moof box 212 and an mdat box 213. In the segment type box (‘styp’) 211, it is possible to represent that the segment is an MPEG-DASH segment with ‘msdh’ brand. The image data (encoded data) and the like of the segment concerned are stored in the mdat box 213.

Then, the event message data adding portion 165 adds the event message box (‘emsg’ box) 171 to the front of the moof box 212. In addition, the DRM rule description adding portion 167 adds the protection system specific header box (‘pssh’ box) 191 to the inside of the moof box 212.

The media segment presenting portion 168 supplies the media segment 121 having such a structure to the content server 102.

<Reproduction Control by MPD>

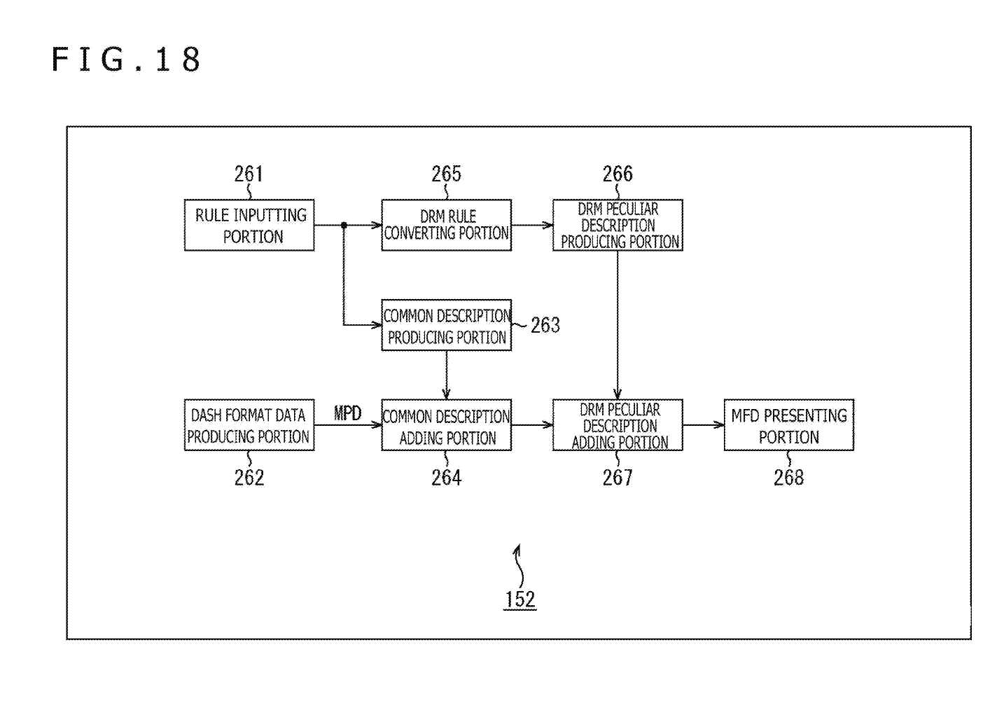

Moreover, it may be adopted that the reproduction control can be carried out by using the MPD. FIG. 18 is a block diagram depicting an example of a main configuration of the MPD producing portion 152. As depicted in FIG. 18, the MPD producing portion 152 has a rule inputting portion 261, a DASH format data producing portion 262, a common description producing portion 263, and a common description adding portion 264. In addition, the MPD producing portion 152 has a DRM rule converting portion 265, a DRM peculiar description producing portion 266, a DRM peculiar description adding portion 267, and an MPD presenting portion 268.

The rule inputting portion 261 acquires the information (reproduction rule) regarding the reproduction control from the outside. The acquisition source of the reproduction rule is arbitrary. For example, the reproduction rule inputted by the user may be accepted by a user interface (UI) or the like of the software, or the file in which the reproduction rule is described may be read. The reproduction rule may be any type of data. For example, the reproduction rule may be an XML file in which the reproduction rule is described with XML. The rule inputting portion 261 supplies the acquired reproduction rule to the common description producing portion 263 and the DRM rule converting portion 265.

The DASH format data producing portion 262 executes processing regarding the production of the MPD 122. The DASH format data producing portion 262 supplies the MPD 122 thus produced to the common description adding portion 264.

The common description producing portion 263 produces a common type of description (common description) which is independent of the DRM and which exhibits the reproduction rule (that is, the content of the reproduction control) supplied from the rule inputting portion 161. The common description producing portion 263 supplies the common description thus produced to the common description adding portion 264.

The common description adding portion 264 adds the common description supplied from the common description producing portion 263 to a predetermined position of the MPD 122 supplied from the DASH format data producing portion 262. The common description adding portion 264 supplies the MPD 122 to which the common description is added to the DRM peculiar description adding portion 267.

The DRM rule converting portion 265 converts the reproduction rule (that is, the content of the reproduction control) supplied from the rule inputting portion 161 into a format peculiar to the DRM. The DRM rule converting portion 265 supplies the reproduction rule converted into the format peculiar to the DRM to the DRM peculiar description producing portion 266.

The DRM peculiar description producing portion 266 produces a description, having the format peculiar to the DRM (DRM peculiar description) which exhibits the reproduction rule (that is, the content of the reproduction control) on the basis of the supplied reproduction rule (having the format peculiar to the DRM). The DRM peculiar description producing portion 266 supplies the DRM peculiar description thus produced to the DRM peculiar description adding portion 267.

The DRM peculiar description adding portion 267 adds the DRM peculiar description supplied from the DRM peculiar description producing portion 266 to a predetermined position of the MPD 122 (the MPD 122 to which the common description is added) supplied from the D common description adding portion 264. The DRM peculiar description adding portion 267 supplies the MPD 122 to which the DRM peculiar description is added to the MPD presenting portion 268.

The MPD presenting portion 268 supplies the MPD 122 thus supplied (the MPD 122 to which the common description, the DRM peculiar description, or both of them are added) to the content server 102.

<Common Description and DRM Peculiar Description>

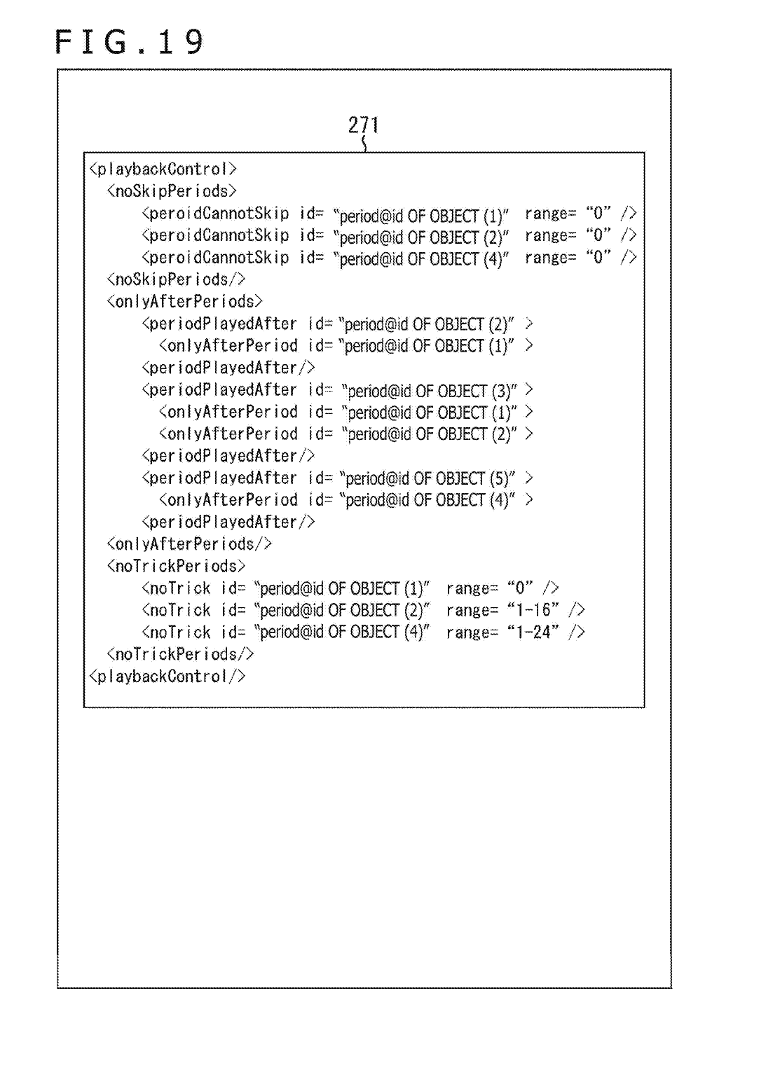

FIG. 19 depicts an example of the common description. In case of the example of FIG. 19, the reproduction rule is described as a common description 271 in the form of the XML document by using a <playbackControl> tag. The common description adding portion 264 adds such a common description 271 to a predetermined position of the MPD 122.

With the common description 271, as depicted in FIG. 19, the reproduction rule regarding a plurality of periods can be defined. In a word, it is also possible to define the reproduction rule regarding a plurality of periods utilizing the DRMs different from one another. In addition, the MPD 122 is not protected, and, for example, can also be changed in the intermediate server 103 or the like. In such a way, since the reproduction rule described in the MPD 122 is utilized under the more various environments, the reproduction rule is described in the format independent of the DRM, thereby enabling the versatility of this description to be enhanced.

It should be noted that when the reproduction rule is desired to be defined in the format peculiar to the DRM, it is only necessary that the DRM peculiar description is produced by using the DRM rule converting portion 265 to the DRM peculiar description adding portion 267 to be added to the MPD 122. In other words, when the DRM peculiar description is unnecessary, the DRM rule converting portion 265 to the DRM peculiar description adding portion 267 can be omitted. Likewise, when the common description is unnecessary, the common description producing portion 263 and the common description adding portion 264 can be omitted.

The reproduction method with which the control method can be defined in the common description or the DRM peculiar description is arbitrary. For example, the control method regarding the various reproduction methods as described above with reference to FIG. 7 and FIG. 8 can be defined.

In such a way, the addition of the description with which the reproduction rule is defined to the MPD 122 enables the broader range of reproduction control such as the reproduction control over a plurality of periods to be carried out. In addition, the reproduction rule can be more readily responded to the update (such as the change, the division, the addition, or the synthesis) of the MPD 122.

In a word, the addition of the description of such reproduction control to the MPD 122 can also be carried out in the intermediate server 103. In this case, it is only necessary that the intermediate server 103 has the configuration of the MPD producing portion 152 depicted in FIG. 18. By adopting such a configuration, for example, not only the intermediate server 103 can add, to the synthetic MPD 123 to be newly produced, the common description or the DRM peculiar description added to the MPD 122 used to produce the synthetic MPD 123, but also the intermediate server 103 can add the common description or the DRM peculiar description regarding the new reproduction rule acquired by the rule inputting portion 261.

Although, of course, the reproduction control can also be carried out only with such a description, as described above, the MPD 122 is not protected and thus can be changed. Therefore, by using the MPD 122 together with the reproduction control using the media segment 121 utilizing the DRM technique described above, the reproduction of the content data can be more reliably controlled. In a word, the reproduction control using the MPD can be combined with the reproduction control using the DRM rule description of the media segment, can also be combined with the reproduction control using the event message data (verification code), can also be combined with both of them, or can also be combined with other methods other than those.

<Flow of Media Segment Processing>

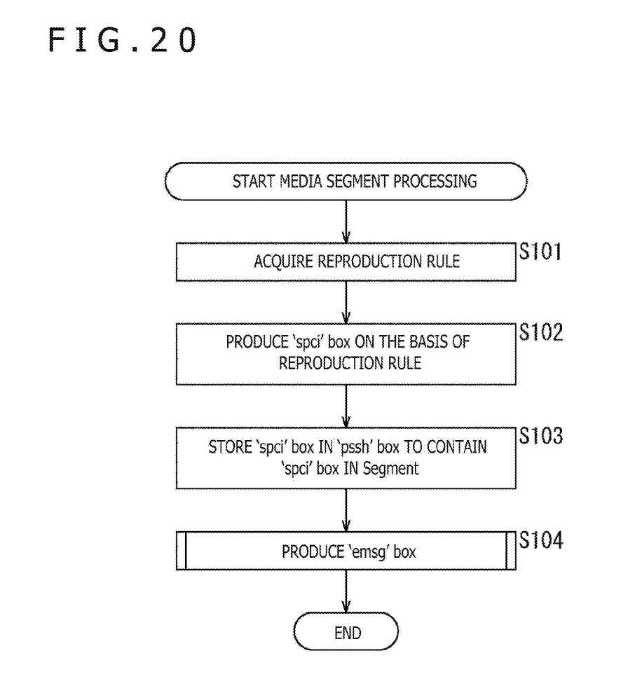

Next, a description will be given with respect to flows of pieces of processing executed in the devices. Firstly, an example of a flow of media segment processing executed by the media segment producing portion 151 of the authoring device 101 will be described with reference to a flow chart of FIG. 20.

When the media segment processing is started, in Step S101, the rule inputting portion 161 acquires the reproduction rule from the outside.

In Step S102, the DRM rule description producing portion 166 produces the DRM rule description on the basis of the reproduction rule acquired in Step S101, produces the segment playback control information box (‘spci’ box), and stores the DRM rule description.

In Step S103, the DRM rule description producing portion 166 produces the protection system specific header box (‘pssh’ box) and stores the segment playback control information box (‘spci’ box) produced in Step S102 in the protection system specific header box (‘pssh’ box). Moreover, the DRM rule description adding portion 167 adds the protection system specific header box (‘pssh’ box) to the media segment.

In Step S104, the MAC value producing portion 163 to the event message data adding portion 165 produce the event message box (‘emsg’ box) and adds the event message box (‘emsg’ box) thus produced to the media segment.

When the event message box (‘emsg’ box) and the protection system specific header box (‘pssh’ box) are added to the media segment in the manner as described above, the media segment processing is ended.

By executing the media segment processing in such a manner, the authoring device 101 (content server 102) not only can realize the more various reproduction control, but also can realize the more detailed control within the segment.

<Flow of Emsg Box Producing Processing>

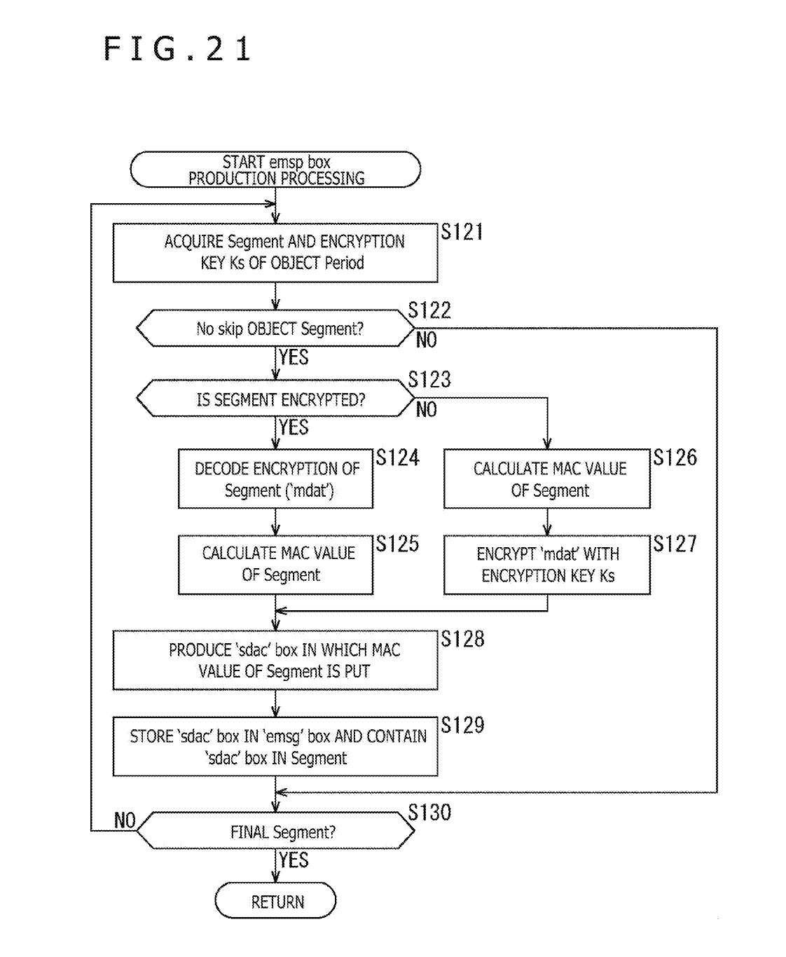

Next, an example of a flow of emsg box producing processing will be described with reference to a flow chart of FIG. 21. When the emsg box producing processing is started, in Step S121, the MAC value producing portion 163 acquires the segment and the encryption key Ks of the object period.

In Step S122, the MAC value producing portion 163 determines whether or not the segment concerned is the No Skip object segment in which the skip reproduction is prohibited. When it is determined that the segment concerned is the No Skip object segment, the processing proceeds to Step S123.

In Step S123, the MAC value producing portion 163 determines whether or not the data (segment (‘mdat’)) is encrypted. When it is determined that the data (segment (‘mdat’)) is encrypted, the processing proceeds to Step S124.

In Step S124, the MAC value producing portion 163 decodes the data (Segment (‘mdat’)). Then, in Step S125, the MAC value producing portion 163 calculates the MAC value of the segment concerned. When the processing in Step S125 is ended, the processing proceeds to Step S128.

On the other hand, when it is determined in Step S123 that the data (Segment (‘mdat’)) is not encrypted, the processing proceeds to Step S126.

In Step S126, the MAC value producing portion 163 calculates the MAC value of the segment concerned. In Step S127, the MAC value producing portion 163 encrypts the data (‘mdat’) of the segment concerned by using the encryption key Ks acquired from the DRM server 105. When the processing in Step S127 is ended, the processing proceeds to Step S128.

In Step S128, the event message data producing portion 164 produces the segment data auth code box (‘sdac’ box), and stores the MAC value.

In Step S129, the event message data producing portion 164 produces the event message box (‘emsg’ box), and stores the segment data auth code box (‘sdac’ box). Moreover, the event message data adding portion 165 adds the event message box (‘emsg’ box) to the media segment. When the processing in Step S129 is ended, the processing proceeds to Step S130.

In addition, when it is determined in Step S122 that the segment concerned is not the No Skip object segment, the processing proceeds to Step S130.

In Step S130, the MAC value producing portion 163 determines whether or not the segment concerned is the final segment. When it is determined that an unprocessed segment is present, the processing returns back to Step S121, and the pieces of processing in and after the processing in Step S121 are repetitively executed. In such a way, the pieces of processing from Step S121 to Step S130 are executed for the respective segments. In Step S130, when it is determined that all the segments are processed, the emsg box producing processing is ended, and the processing returns back to FIG. 20.

By executing the emsg box producing processing in such a manner, the authoring device 101 (content server 102) can more reliably realize the desired reproduction control (the reproduction of the content data can be more reliably controlled).

<Flow of MPD Processing>

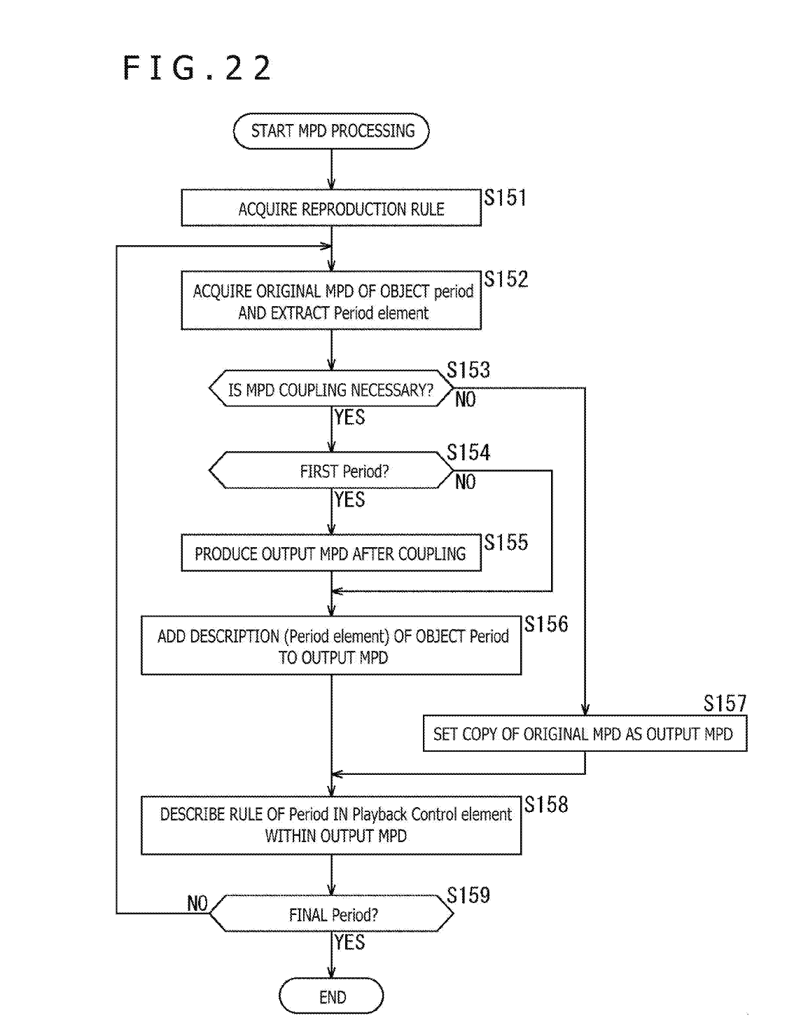

Next, an example of a flow of the MPD processing will be described with reference to a flow chart of FIG. 22. When the MPD processing is started, in Step S151, the rule inputting portion 261 acquires the reproduction rule from the outside.

In Step S152, the DASH format data producing portion 262 acquires the original MPD of the object period, and extracts a period element.

In Step S153, the DASH format data producing portion 262 determines whether or not the coupling of the MPD is necessary. When it is determined that the coupling of the MPD is necessary, the processing proceeds to Step S154.

In Step S154, the DASH format data producing portion 262 determines whether or not the period concerned is the first period. When it is determined that the period concerned is the first period, the processing proceeds to Step S155.

In Step S155, the DASH format data producing portion 262 produces an output MPD after the coupling. When the processing in Step S155 is ended, the processing proceeds to Step S156. On the other hand, when it is determined in Step S154 that the period concerned is not the first period, the processing proceeds to Step S156.

In Step S156, the DASH format data producing portion 262 adds the description (period element) of the object period to the output MPD. When the processing in Step S156 is ended, the processing proceeds to Step S158. On the other hand, when it is determined in Step S153 that the MPD coupling is unnecessary, the processing proceeds to Step S157.

In Step S157, the DASH format data producing portion 262 sets a copy of the original MPD as the output MPD. When the processing in Step S157 is ended, the processing proceeds to Step S158.

In Step S158, the common description producing portion 263 produces the common description with which the reproduction rule of the period concerned is defined. Then, the common description adding portion 264 describes the common description within the output MPD by using the <Playback Control element> tag.

In Step S159, the MPD producing portion 152 determines whether or not the period of the processing object is the final period. When it is determined that an unprocessed period is present, the processing returns back to Step S152 and the pieces of processing in and after Step S152 are repetitively executed. The pieces of processing from Step S152 to Step S159 are executed for the periods. Then, when it is determined in Step S159 that the period of the processing object is the final period, the MPD processing is ended.

By executing the MPD processing in such a manner, the authoring device 101 (content server 102) can carry out the broader range of the reproduction control.

It should be noted that the intermediate server 103 can also execute similar MPD processing. In a word, the flow chart of FIG. 22 can also be applied to the description of the flow of the MPD processing by the intermediate server 103. Therefore, the intermediate server 103 can carry out the broader range of the reproduction control. In addition, by executing the MPD processing in such a way, the intermediate server 103 can more readily carry out the suitable reproduction control in response to the update of the MPD. For example, the intermediate server 103 not only can add, to the synthetic MPD 123 to be newly produced, the common description or the DRM peculiar description added to the MPD 122 used to produce the synthetic MPD 123, but also can add the common description or the DRM peculiar description regarding the new reproduction rule acquired by the rule inputting portion 261.

<Reproduction Client>

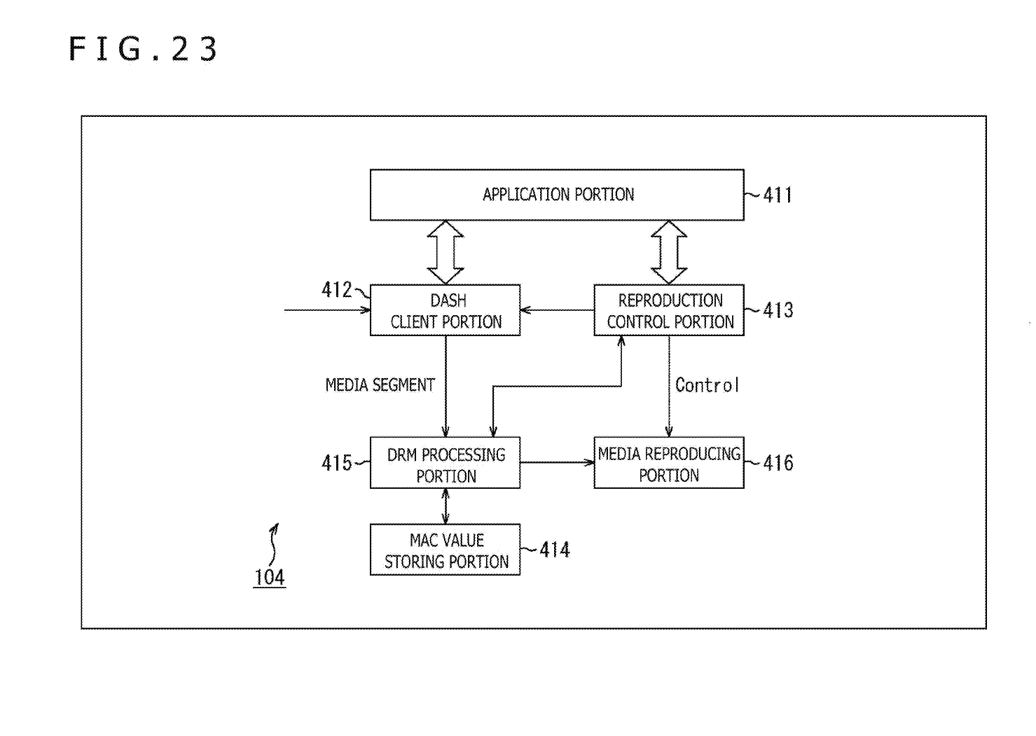

Next, the reproduction side will be described. FIG. 23 is a block diagram depicting an example of a main configuration of the reproduction client 104 (FIG. 5). As depicted in FIG. 23, the reproduction client 104 has an application portion 411, a DASH client portion 412, a reproduction control portion 413, an MAC value storing portion 414, a DRM processing portion 415, and a media reproducing portion 416.

The application portion 411 has a user interface and the like, and receives an instruction input issued from the user. The DASH client portion 412 executes the processing regarding the acquisition of the media segment. For example, the DASH client portion 412 acquires and interprets the MPD from the intermediate server 103, the content server 102 or the like, selects the media segment to be reproduced, and acquires the media segment to be reproduced from the content server 102 or the like.

The reproduction control portion 413 executes the processing regarding the reproduction control of the content data. For example, the reproduction control portion 413 analyzes the media segment acquired from the DASH client portion 412 and carries out the reproduction control for the content data.

The MAC value storing portion 414 stores therein the information regarding the MAC value such as the comparison result and the like of the MAC value. The DRM processing portion 415 executes the processing regarding the DRM. For example, the DRM processing portion 415 carries out the acquisition of the DRM license necessary for the reproduction, processing for decoding the media segment encrypted, and the like. The media control portion 416 carries out the decoding, displaying/outputting, and the like for the media after the DRM decoding.

In the technical license of the DRM, it is requested for the whole of those to abide the rule decided in the DRM. However, the strength required for the fastness properties of the mounting is weaker than that in the DRM processing portion 415 and the media reproducing portion 416 with respect to the pieces of processing of the processing portions including the application portion 411 to the reproduction control portion 413. For example, even in the case where the application portion 411 or the DASH client portion 412 is modified so as to take a detour for the reproduction rule, so that the manipulation which is essentially prohibited is carried out, the DRM processing portion 415 can detect this situation or can reduce the effectiveness of the detour.

<Flow of Reproduction Processing>

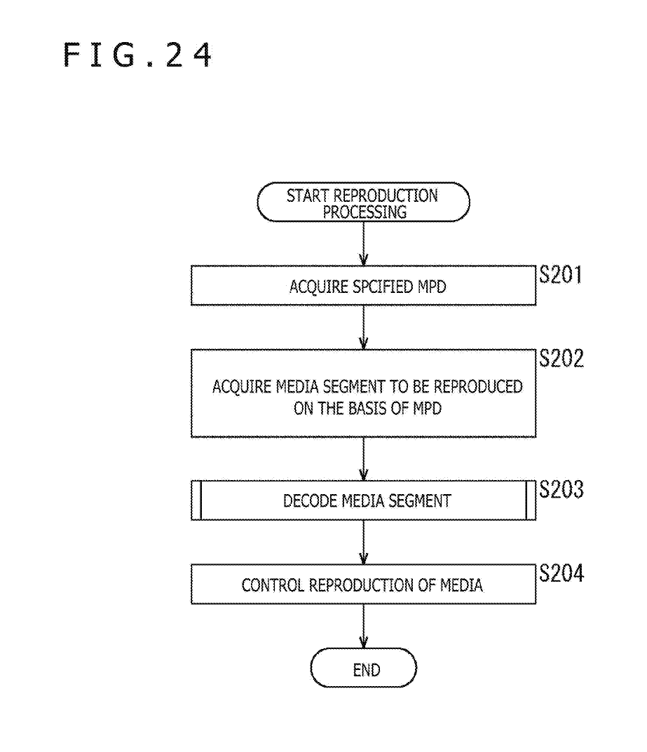

Next, a description will be given with respect to an example of a flow of the processing executed by the reproduction client 104. Firstly, a description will be given with respect to an example of a flow of reproduction processing executed by the reproduction client 104 with respect to a flow chart of FIG. 24.

When the reproduction processing is started, in Step S201, the DASH client portion 412 acquires the specified MPD.

In Step S202, the DASH client portion 412 acquires the media client to be reproduced on the basis of the MPD acquired in Step S201.

In Step S203, the DRM processing portion 415 decodes the media segment encrypted by using the DRM technique.

In Step S204, the reproduction control portion 413 controls the reproduction of the media segment decoded by the processing in Step S203 executed by the media reproducing portion 416 on the basis of the processing result in Step S203.

When the processing in Step S204 is ended, the reproduction processing is ended.

<Flow of Media Segment Decoding Processing>

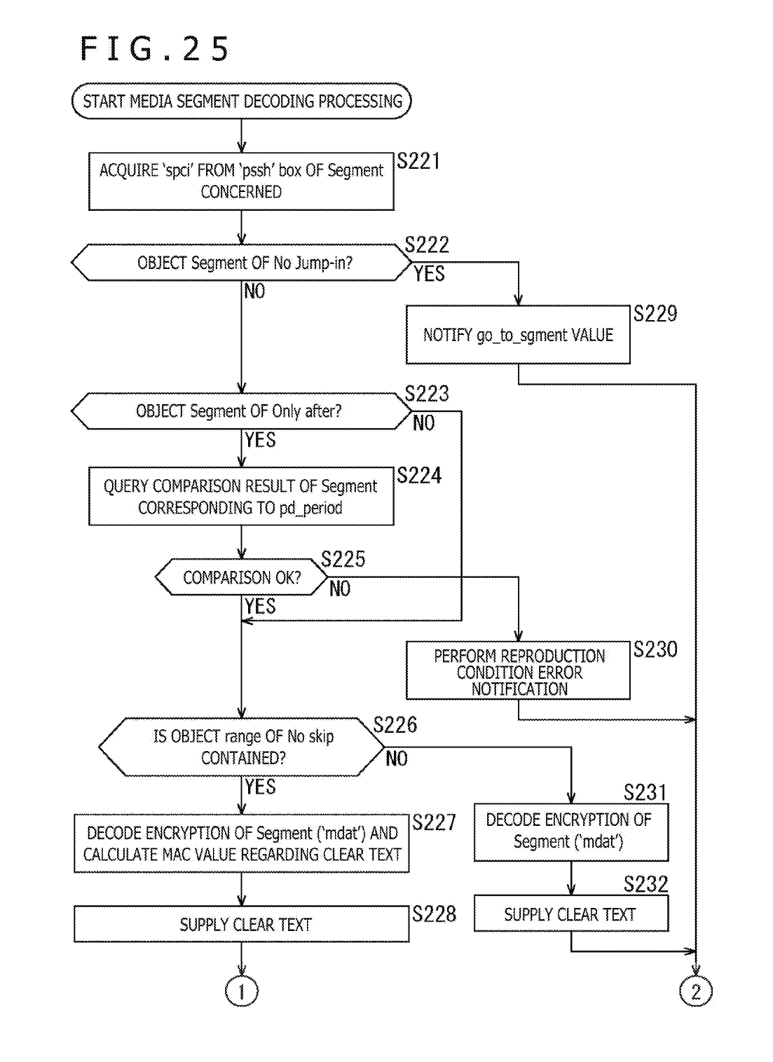

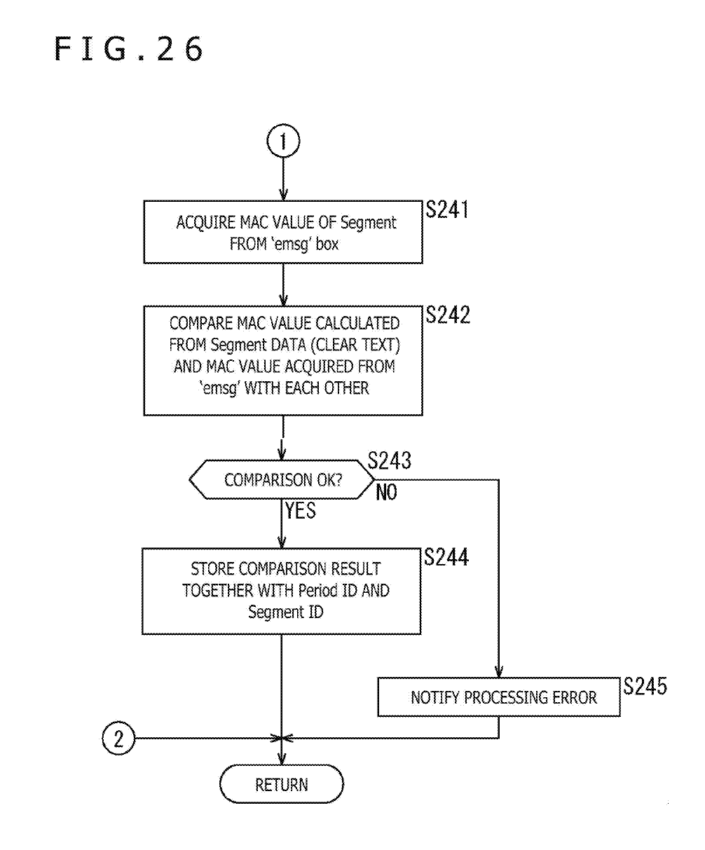

Next, a description will be given with respect to an example of a flow of the media segment decoding processing executed in Step S203 of FIG. 24 with reference to flow charts of FIG. 25 and FIG. 26.

When the media segment decoding processing is started, in Step S221, the DRM processing portion 415 acquires the segment playback control information box (‘spci’ box) from the protection system specific header box (‘pssh’ box) of the segment concerned.

In Step S222, the DRM processing portion 415 determines whether or not the segment concerned is the object segment of No Jump-In in which the reproduction from the middle of the predetermined period is prohibited. When it is determined that the segment concerned is not the object segment of No Jump-In, the processing proceeds to Step S223.

In Step S223, the DRM processing portion 415 determines whether or not the segment concerned is the object segment of Only After. When it is determined that the segment concerned is the object segment of Only After, the processing proceeds to Step S224.

In Step S224, the DRM processing portion 415 queries the comparison result of the segment concerned of the period (pb_period_id) becoming the object of Only After to the MAC value storing portion 414. In Step S225, the DRM processing portion 415 determines whether or not the comparison result is comparison OK (succeeding in the comparison). When it is determined that the comparison of the segment concerned is OK, the processing proceeds to Step S226.

In Step S226, the DRM processing portion 415 determines whether or not the segment concerned contains the object range of No skip. When it is determined that the segment concerned contains the object range of No skip, the processing proceeds to Step S227.

In Step S227, the DRM processing portion 415 decodes the encrypted data (Segment (‘mdat’)). In addition, the DRM processing portion 415 calculates the MAC value of the decoded data (Segment (‘mdat’)).

In Step S228, the DRM processing portion 415 supplies the decoded data (segment (‘mdat’)) to the media reproducing portion 416. When the processing in Step S228 is ended, the processing proceeds to Step S241 of FIG. 26.

In Step S241 of FIG. 26, the DRM processing portion 415 acquires the MAC value of the segment concerned from the event message box (‘emsg’ box). In Step S242, the DRM processing portion 415 compares the MAC value calculated from the data (Segment (‘mdat’)) decoded by the processing in Step S227, and the MAC value acquired from the event message box (‘emsg’ box) by the processing in Step S241 with each other.

In Step S243, the DRM processing portion 415 determines whether or not the comparison is OK (whether or not the MAC values agree with each other). When it is determined that the comparison is OK (succeeding in the comparison), the processing proceeds to Step S244.

In Step S244, the MAC value storing portion 414 stores therein the comparison result determined in Step S243 together with the identification information (Period ID) of the period concerned and the identification information (Segment ID) of the segment concerned. When the processing in Step S244 is ended, the media segment decoding processing is ended and the processing returns back to FIG. 24.

On the other hand, when it is determined in Step S243 of FIG. 26 that the comparison is NG (failing in the comparison), the processing proceeds to Step S245. In Step S245, the DRM processing portion 415 notifies the reproduction control portion 413 of the processing error. When the processing in Step S245 is ended, the media segment decoding processing is ended and the processing returns back to FIG. 24.

In addition, when it is determined in Step S222 of FIG. 25 that the segment concerned is the object segment of No Jump-In, the processing proceeds to Step S229. In Step S229, to the reproduction control portion 413, the DRM processing portion 415 notifies the reproduction control portion 413 of the processing error and a go_to_segment value with which the jump destination (reproduction start position) is specified. The reproduction control portion 413 carries out the reproduction control for Jump-In by using the go_to_segment value. When the processing in Step S229 is ended, the media segment decoding processing is ended, and the processing returns back to FIG. 24.

On the other hand, when it is determined in Step S225 of FIG. 25 that the comparison result is NG (failing in the comparison), the processing proceeds to Step S230. In Step S230, the DRM processing portion 415 carries out the processing error notification and the reproduction condition error notification for the reproduction control portion 413. When the processing in Step S230 is ended, the media segment decoding processing is ended, and the processing returns back to FIG. 24.

In addition, when it is determined in Step S226 of FIG. 25 that the segment concerned does not contain the object range of No skip, the processing proceeds to Step S231. In Step S231, the DRM processing portion 415 decodes the encrypted data (Segment (‘mdat’)).

In Step S232, the DRM processing portion 415 supplies the decoded data (Segment (‘mdat’)) to the media reproducing portion 416. When the processing in Step S232 is ended, the media segment decoding processing is ended, and the processing returns back to FIG. 24.

By executing the pieces of processing in the manner as described above, the reproduction client 104 can more reliably reproduce the content data in accordance with the reproduction control specified from the delivery side. In addition, it is possible to realize the more various and detailed reproduction control.

### 2. Second Embodiment

<Other Example of Event Message Box>

It should be noted that the segment playback control information box (‘spci’ box) may be stored not only in the protection system specific header box (‘pssh’ box), but also in the event message box (‘emsg’ box). It is supposed that the event message box (‘emsg’ box) is essentially inserted in the processing of the service layer.

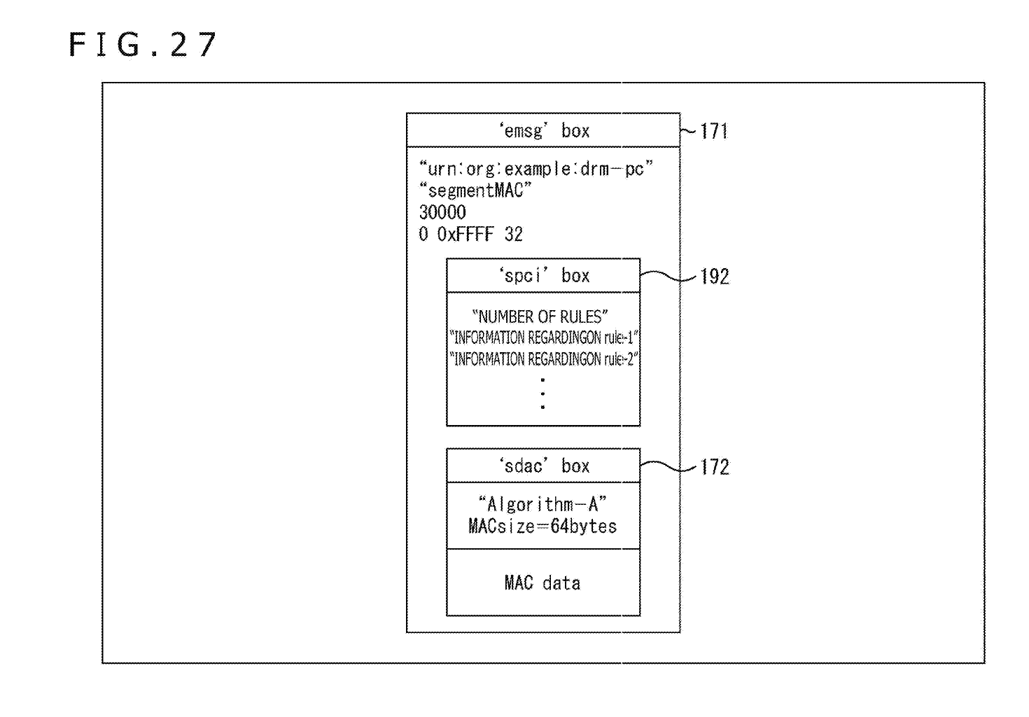

An example of a structure of the event message box (‘emsg’ box) in this case is depicted in FIG. 27. As depicted in FIG. 27, in this case, in addition to the segment data auth code box (‘sdac’ box) 172, the segment playback control information box (‘spci’ box) 192 is also stored in the event message box (‘emsg’ box) 171.

When the segment playback control information box (‘spci’ box) is stored in the event message box (‘emsg’ box), the information regarding the segment playback control information box (‘spci’ box) stored in the event message box (‘emsg’ box) is prioritized over the information regarding the segment playback control information box (‘spci’ box) stored in the protection system specific header box (‘pssh’ box) within the same segment.

In a word, the information regarding the segment playback control information box (‘spci’ box) within the protection system specific header box (‘pssh’ box) is overwritten by the information regarding the segment playback control information box (‘spci’ box) within the event message box (‘emsg’ box).

Adopting such a procedure is especially effective when the period or segment previously prepared is dynamically restructured by aggregation service or the like to be presented to the reproduction client. That is to say, it is possible to change the rule to be applied without rewriting the protection system specific header box (‘pssh’ box) within the ‘moof’ box. For this reason, ISOBMFF knowledge with which the data within the ‘moof’ box previously prepared is rewritten is not required and the change of the rule can be readily realized.

<Event Message Box>

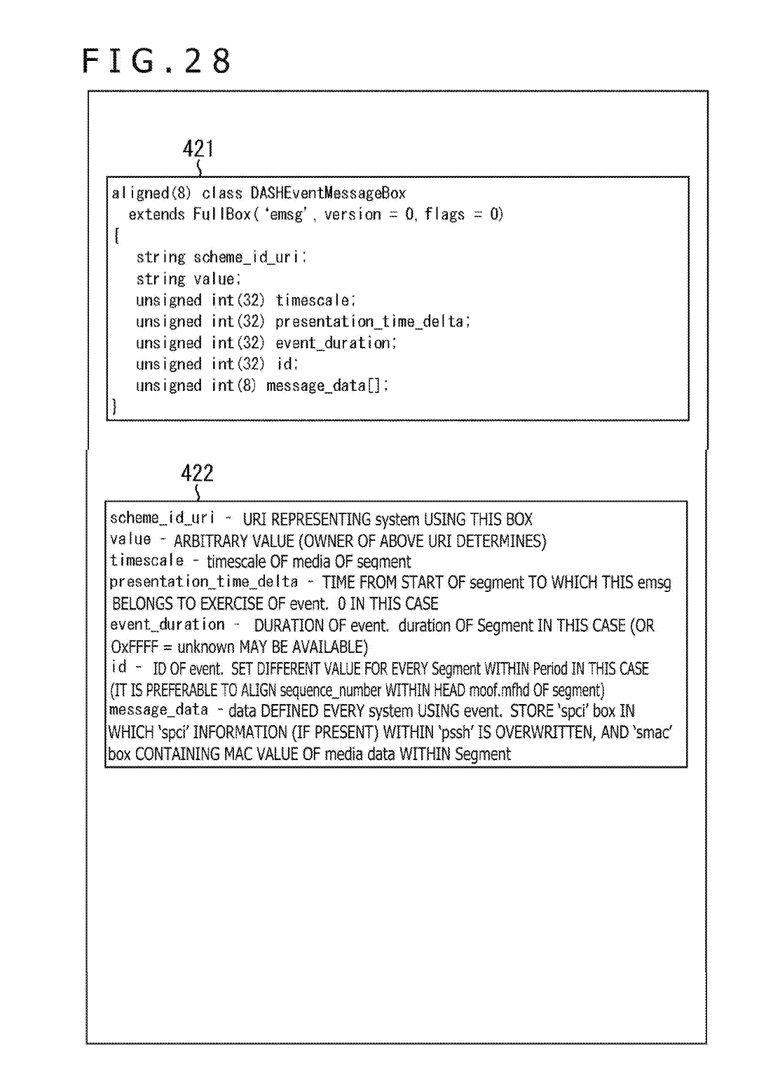

An example (description example) of syntax of the event message box (‘emsg’ box) 171 in this case is represented in syntax 421 of FIG. 28. In addition, an example of semantics (semantics of the event message box (‘emsg’ box) 171) of the parameters used in the syntax 421 is represented in semantics 422 of FIG. 28. As represented in the semantics 422, in this case, if there is the information regarding the segment playback control information box (‘spci’ box) within the protection system specific header box (‘pssh’ box), it is overwritten to message_data.

<Flow of Emsg Box Producing Processing>

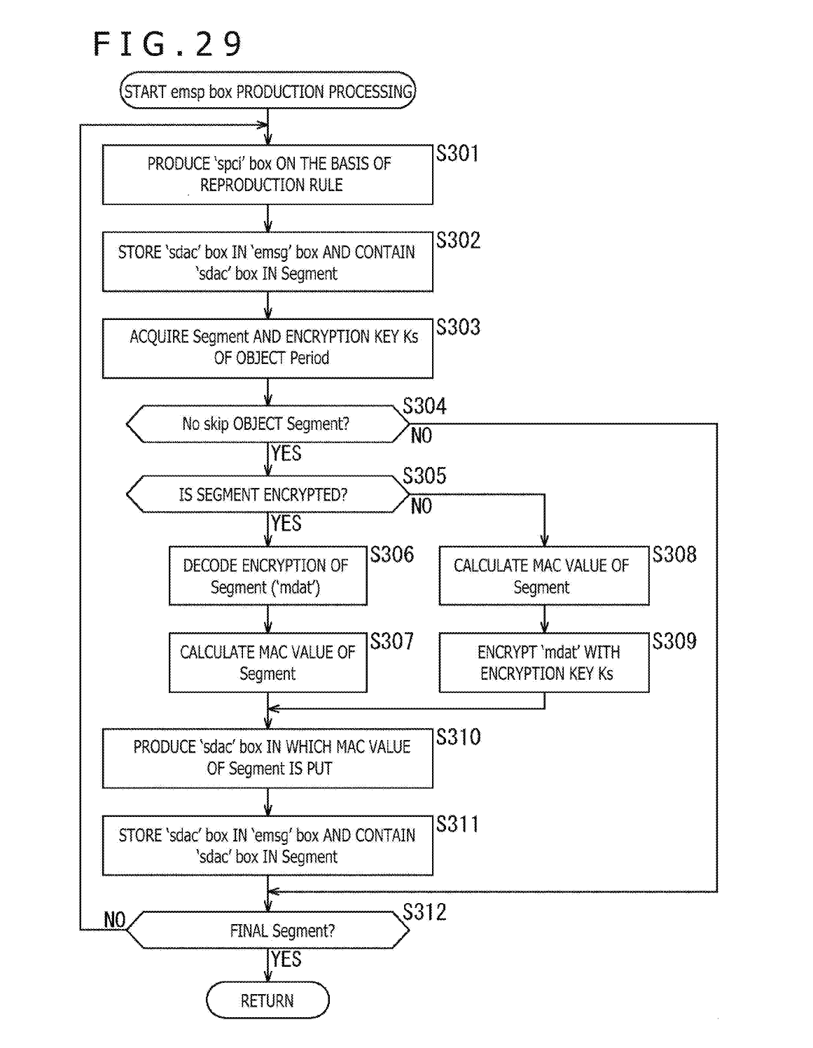

Next, a description will be given with respect to an example of a flow of emsg box producing processing in this case with reference to a flow chart of FIG. 29.

In this case, when the emsg box producing processing is started, in Step S301, the DRM rule description producing portion 166 produces the DRM rule description on the basis of the reproduction rule, and further produces the segment playback control information box (‘spci’ box), and stores the DRM rule description thereof.

In Step S302, the DRM rule description producing portion 166 produces the event message box (‘emsg’ box), and stores the segment playback control information box (‘spci’ box) produced in Step S301 in the event message box (‘emsg’ box).

The pieces of processing from Step S303 to Step S312 are executed similarly to the pieces of processing from Step S121 to Step S130 of FIG. 21.

By executing the emsg box producing processing in such a manner, the authoring device 101 (content server 102) can store the DRM rule description in the event message box (‘emsg’ box). As a result, the update of the DRM rule description can be more readily carried out.

<Flow of Media Segment Decoding Processing>

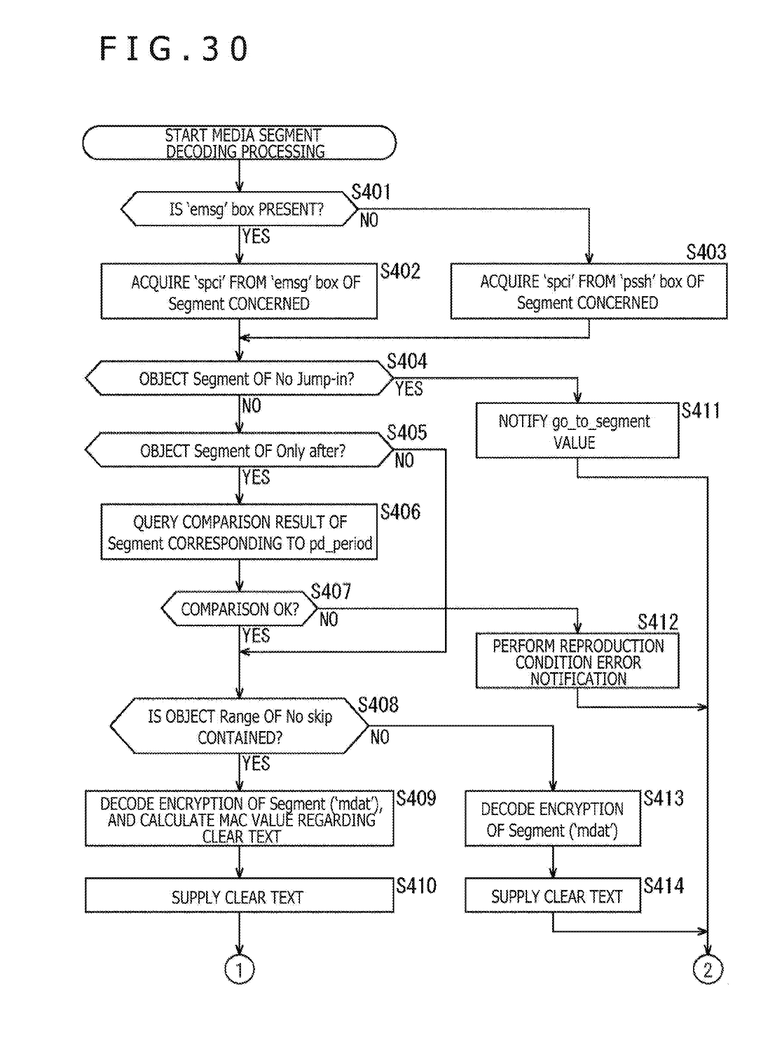

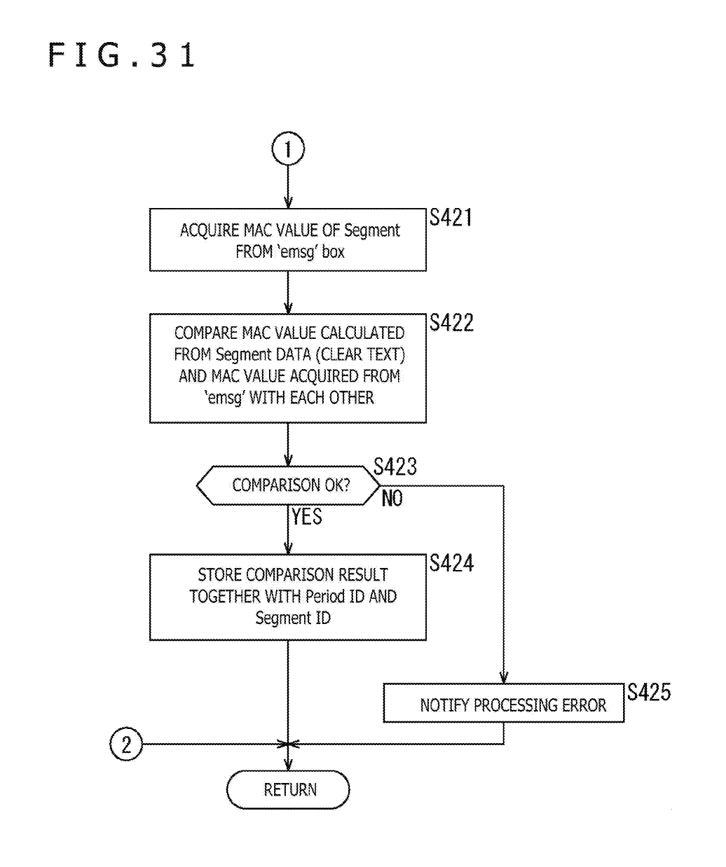

Next, a description will be given with respect to an example of a flow of the media segment decoding processing executed in Step S203 of FIG. 24 by the reproduction client 104 with reference to flow charts of FIG. 30 and FIG. 31.

In this case, when the media segment decoding processing is started, in Step S401, the DRM processing portion 415 determines whether or not the event message box (‘emsg’ box) of the segment concerned is present. When it is determined that the event message box (‘emsg’ box) is present, the processing proceeds to Step S402.

In Step S402, the DRM processing portion 415 acquires the segment playback control information box (‘spci’ box) from the event message box (‘emsg’ box) of the segment concerned. When the processing step S402 is ended, the processing proceeds to Step S404.

On the other hand, when it is determined in Step S401 that the event message box (‘emsg’ box) of the segment concerned is absent, the processing proceeds to Step S403. In Step S403, the DRM processing portion 415 acquires the segment playback control information box (‘spci’ box) from the protection system specific header box (‘pssh’ box) of the segment concerned. When the processing in Step S403 is ended, the processing proceeds to Step S404.

The pieces of processing from Step S404 to Step S414 of FIG. 30 are executed similarly to the pieces of processing from Step S222 to Step S232 of FIG. 25. In addition, the pieces of processing from Step S421 to Step S425 of FIG. 31 are executed similarly to the pieces of processing from Step S241 to Step S245 of FIG. 26.

By executing the media segment decoding processing in the manner as described above, in this case as well, the reproduction client 104 can more reliably reproduce the content data in accordance with the reproduction control specified from the delivery side. In addition, the reproduction client 104 can realize the more various and detailed reproduction control.

### 3. Third Embodiment

<Delivery System>

The devices described above in the embodiments, for example, can be utilized in the delivery system for delivering a still image or a moving image. Hereinafter, this case will be described.

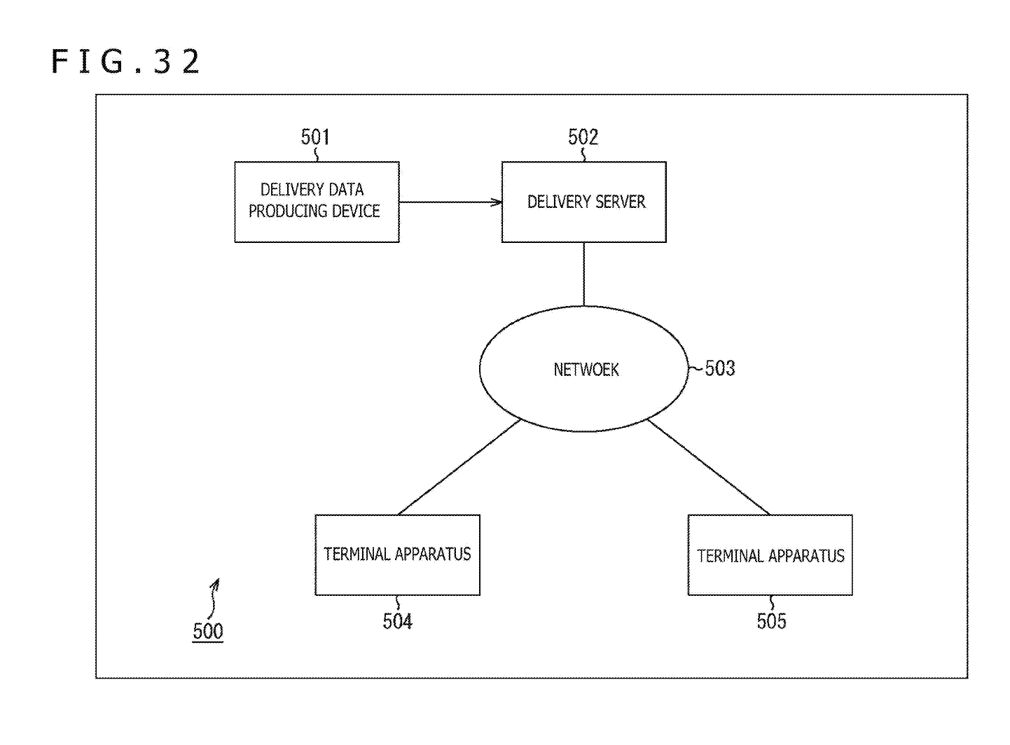

FIG. 32 is a block diagram depicting an example of a main configuration of the delivery system to which the present technique is applied. A delivery system 500 depicted in FIG. 32 is a system for delivering a still image and a moving image. As depicted in FIG. 32, the delivery system 500 has a delivery data producing device 501, a delivery server 502, a network 503, a terminal apparatus 504, and a terminal apparatus 505.

The delivery data producing device 501 produces delivery data having a format for delivery from the data of still image or moving image to be delivered. The delivery data producing device 501 supplies the delivery data thus produced to the delivery server 502. The delivery server 502 stores the delivery data produced by the delivery data producing device 501 in a storage portion or the like and manages the same. In addition, the delivery server 502 presents the delivery service of the delivery data for the terminal apparatus 504 or the terminal apparatus 505 through the network 503.

The network 503 is a communication network serving as a communication medium. The network 503 may be any type of communication network, and thus may be a wired communication network, a wireless communication network, or both of them. For example, the network 503 may be a wired LAN (Local Area Network), a wireless LAN, a public telephone network, a broad band network for a wireless moving body such as a so-called 3G network or 4G network, the Internet or the like, or may be a combination thereof. In addition, the network 503 may be a single communication network or a plurality of communication networks. In addition, for example, a part of or the whole of the network 503 may include a communication cable, complying with predetermined standards, such as a USB (Universal Serial Bus) cable or an HDMI (High-Definition Multimedia Interface) (registered trademark) cable.

The delivery server 502, the terminal apparatus 504, and the terminal apparatus 505 are connected to the network 503 so as to be able to communicate with one another. A method of connection to the network 503 is arbitrary. For example, these apparatuses may be connected to the network 503 in a wired communication style or a wireless communication style. In addition, for example, these apparatuses may be connected to the network 503 through an arbitrary communication apparatus (communication equipment) such as an access point, a relay system or a base station.

The terminal apparatus 504 and the terminal apparatus 505 are each an arbitrary electronic apparatus, having a communication function, such as a mobile phone, a smartphone, a tablet-type computer or a note-type computer. The terminal apparatus 504 or the terminal apparatus 505, for example, requests the delivery server 502 to deliver the delivery file on the basis of an instruction issued from the user.

The delivery server 502 transmits the requested delivery data to the request source. The terminal apparatus 504 or the terminal apparatus 505 making the request to carry out the delivery receives and reproduces the delivery data.

In such a delivery system 500, the present technique described above in the embodiments is applied to the delivery data producing device 501. That is to say, the authoring device 101 described above is used as the delivery data producing device 501.

In addition, the present technique described above in the embodiments is applied as the delivery server 502. That is to say, the content server 102, the intermediate server 103, the DRM server 105 or the like described above is used as the delivery server 502.

In addition, the present technique described above in the embodiments is applied as the terminal apparatus 504 or the terminal apparatus 505. That is to say, the reproduction client 104 described above is used as the terminal apparatus 504 or the terminal apparatus 505.

By adopting such a configuration, the delivery data producing device 501, the terminal apparatus 504 and the terminal apparatus 505 can offer the similar effects to those of the embodiments described above. In a word, the delivery system 500 can more reliably control the reproduction of the content data.

### 4. Fourth Embodiment

<Computer>

The series of pieces of processing described above can be executed by the hardware, or by the software. When the series of pieces of processing described above are executed by the software, the program constituting that software is installed in the computer. Here, the computer includes a computer incorporated in the dedicated hardware, a computer, for example, a general-purpose personal computer which can execute the various kinds of functions by installing the various programs, and the like.

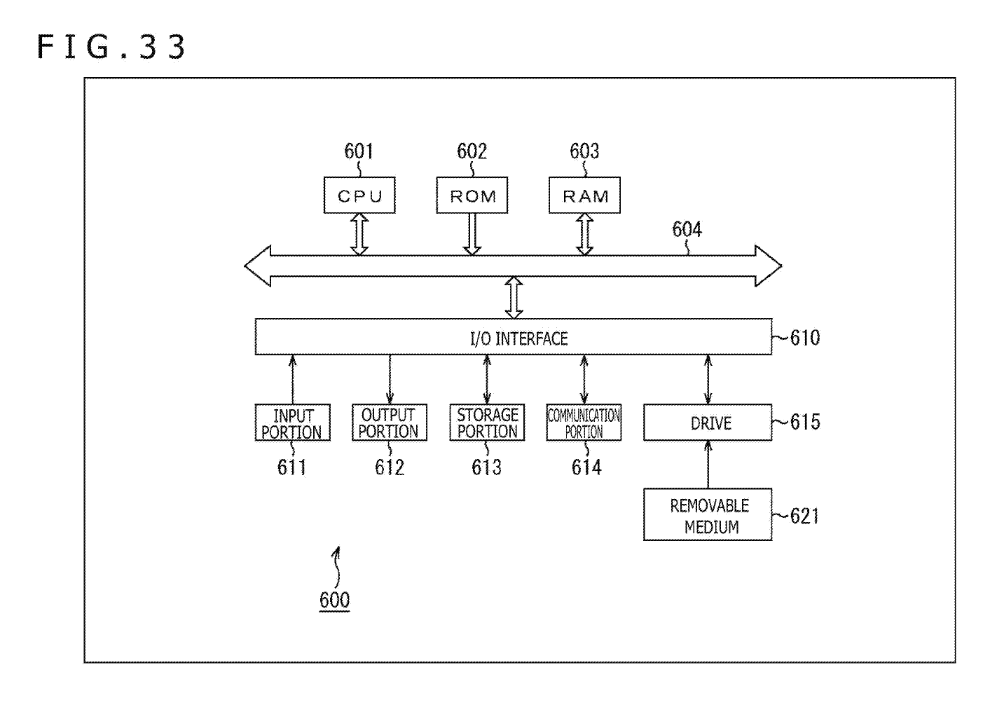

FIG. 33 is a block diagram depicting an example of a configuration of hardware of a computer which executes the series of pieces of processing in accordance with a program.

In the computer 600 depicted in FIG. 33, a CPU (Central Processing Unit) 601, a ROM (Read Only Memory) 602, and a RAM (Random Access Memory) 603 are connected to one another through a bus 604.

An I/O (Input/Output) interface 610 is also connected to the bus 604. An input portion 611, an output portion 612, a storage portion 613, a communication portion 614, and a drive 615 are connected to the I/O interface 610.

The input portion 611, for example, includes a keyboard, a mouse, a microphone, a touch panel, an input terminal or the like. The output portion 612, for example, includes a display, a speaker, an output terminal or the like. The storage portion 613, for example, includes a hard disc, a RAM disc, a nonvolatile memory, or the like. The communication portion 614, for example, includes a network interface. The drive 615 drives a removable medium 621 such as a magnetic disc, an optical disc, a magneto-optical disc or a semiconductor memory.

In the computer configured in the manner as described above, the CPU 601, for example, loads the program stored in the storage portion 613 into the RAM 603 through the I/O interface 610 and the bus 604, and executes the program, thereby executing the series of pieces of processing described above. The data or the like which is necessary for executing the various kinds of processing by the CPU 601 is also suitably stored in the RAM 603.

The program which is to be executed by the computer (CPU 601), for example, can be recorded in the removable medium 621 as a package medium or the like to be applied. In this case, by loading the removable medium 621 into the drive 615, the program can be installed in the storage portion 613 through the I/O interface 610.

In addition, the program can be provided through a wired or wireless transmission medium such as a local area network, the Internet, or a digital satellite broadcasting. In this case, the program can be received in the communication portion 614, thereby being installed in the storage portion 613.

In addition thereto, the program can be installed in the ROM 602 or the storage portion 613 in advance.

It should be noted that the program which is to be executed by the computer may be a program in accordance with which the pieces of processing are executed in a time series along the order described in this description, or may be a program in accordance with which the pieces of processing are executed in parallel or at a necessary timing when a call is made, or the like.

In addition, in the present description, the steps in which the program recorded in the recording medium is described contains the pieces of processing which are to be executed in parallel or individually even when not being necessarily processed in a time series manner as well as the pieces of processing which are to be executed in a time series manner along the described order.

In addition, in the present description, a system means a set of a plurality of constituent elements (the apparatus, the module (parts), and the like), and it does not matter whether or not all the constituent elements are present in the same chassis. Therefore, a plurality of apparatuses which are accommodated in the different chassis and are connected through the network or one apparatus having a plurality of modules accommodated in one chassis is a system.

In addition, in the above, the configuration described as one apparatus (or the processing portion) may be divided in the form of a plurality of apparatuses (or the processing portions). In contrast, in the foregoing, the configurations described as a plurality of apparatuses (or the processing portions) may be collectively configured in the form of one apparatus (or the processing portion). In addition, the constituent elements other than those described above may also be added to the configuration of the apparatuses (or the processing portions). Moreover, if the configuration and operation as the whole system are substantially the same, a part of a configuration of a certain apparatus (or a certain processing portion) may be included in a configuration of other apparatus (or other processing portion).

Although the suitable embodiments of the present disclosure have been described in detail so far with the reference to the accompanying drawings, the technical scope of the present disclosure is by no means limited to such examples. It is obvious that those having ordinary skills in the technical field of the present disclosure could conceive of various modified changes or corrected changes within the scope of the technical concept described in the claims. Thus, it is understood that those, of course, belong to the technical scope of the present disclosure.

For example, the present technique can adopt a configuration of cloud computing in which one function is jointly shared among a plurality of apparatuses through the network.

In addition, steps described in the flow charts described above not only can be executed in one apparatus, but also can be executed so as to be shared among a plurality of apparatuses.

Moreover, when a plurality of pieces of processing are contained in one step, a plurality of pieces of processing contained in the one step not only can be executed by one apparatus, but also can be executed so as to be shared among a plurality of apparatuses.

In addition, in the present description, the example in which the various kinds of information are added to the content data such as the stream data or the MPD to be transmitted from the supply side to the acquisition side (reproduction side) has been described so far. Here, “add” means that the various kinds of information are contained in the stream data in an arbitrary state. In a word, the meaning of all the expressions corresponding to the action, in which the various kinds of information, such as “insert,” “store,” “multiplex,” “superimpose,” “increase,” “add,” “describe,” “write,” “attach,” “couple,” “unite,” “synthesize,” and “integrate,” shall be contained in the stream data in an arbitrary state.

In addition, the various kinds of information may be transmitted from the supply side to the acquisition side (reproduction side) as the different data associated with the content data without being added to the content data such as the stream data or the MPD. Here, the wording “associated with” means a state in which during the reproduction of the content data, the various kinds of information corresponding to the content data concerned can be utilized. For example, the content data and the various kinds of information corresponding to the content data concerned may be linked to each other by using the identification information or the like. In addition, a correspondence relation between the content data and the various kinds of information may be managed by using management information separately prepared. In other words, if the various kinds of information are in a state in which they can be utilized during the reproduction of the corresponding content data, then, the various kinds of information may be in any state.

For example, the various kinds of information associated with the content data may be transmitted through a transmission path different from the transmission path through which the content data concerned is transmitted. In addition, the various kinds of information associated with the content data may be recorded in a recording medium different from the recording medium in which the content data concerned is recorded. Moreover, the content data and the various kinds of information may be associated with each other in arbitrary units of a plurality of frames of an image, one frame of an image, a part of a frame of an image, or the like.

It should be noted that the present technique can also adopt the following constitutions.

(1) An image processing apparatus, including:

a verification code producing portion configured to produce, with respect to a segment with which reproduction control for stream data obtained by encoding image data is carried out, a verification code of the stream data of the segment; and

a verification code adding portion configured to add the verification code produced by the verification code producing portion to the stream data.

(2) The image processing apparatus according to (1), in which the verification code producing portion produces a hash value for the stream data of the segment before being encrypted by using key information used in encryption or decoding of the stream data of the segment, and makes the hash value thus produced the verification code.

(3) The image processing apparatus according to (1) or (2), further including:

an event message box producing portion configured to produce an event message box in which an event message is stored, and store the verification code produced by the verification code producing portion in the event message box thus produced,

in which the verification code adding portion adds the event message box which is produced by the event message box producing portion and in which the verification code is stored to the stream data.

(4) The image processing apparatus according to (3), in which the event message box producing portion further stores a DRM (Digital Rights Management) rule description in which content of the reproduction control is described as a rule of DRM in the event message box.

(5) The image processing apparatus according to any one of (1) to (4), further including:

a DRM (Digital Rights Management) rule description producing portion configured to produce a DRM rule description in which content of the reproduction control is described as a rule of DRM; and

a DRM rule description adding portion configured to add the DRM rule description produced by the producing portion to the stream data.

(6) The image processing apparatus according to (5), in which the content of the reproduction control contains prohibition of skip reproduction and prohibition period specification, specification of a period for which reproduction is required in advance, prohibition of trick reproduction and prohibition period specification, prohibition of jump-in reproduction, prohibition period specification, and reproduction start position specification of the stream data.

(7) The image processing apparatus according to any one of (1) to (6), further including:

a common description producing portion configured to produce a common description which is of a type independent of DRM (Digital Rights Management) exhibiting content of the reproduction control; and

a common description adding portion configured to add a common description produced by the common description producing portion to an MPD (Media Presentation Description) as control information regarding the reproduction of the stream data.

(8) The image processing apparatus according to (7), in which the content of the reproduction control contains prohibition of skip reproduction and prohibition period specification, specification of a period for which reproduction is required in advance, and prohibition of trick reproduction and prohibition period specification of the stream data.

(9) An image processing method, including:

producing, with respect to a segment with which reproduction control for stream data obtained by encoding image data is carried out, a verification code of the stream data of the segment; and

adding the verification code produced to the stream data.

(10) An image processing apparatus, including:

a production portion configured to produce, with respect to a segment with which reproduction control for stream data obtained by encoding image data is carried out, a verification code of the stream data of the segment;

a comparison portion configured to compare the verification code produced by the production portion and a verification code added to the stream data with each other; and

a reproduction control portion configured to control the reproduction of the stream data of the segment, a following segment, or both of them in response to agreement or disagreement between the verification codes in the comparison by the comparison portion.

(11) An image processing method, including:

producing, with respect to a segment with which reproduction control for stream data obtained by encoding image data is carried out, a verification code of the stream data of the segment;

comparing the verification code thus produced and a verification code added to the stream data with each other; and

controlling the reproduction of the stream data of the segment, a following segment, or both of them in response to agreement or disagreement between the verification codes.

(12) An image processing apparatus, including:

a production portion configured to produce, with respect to a segment with which reproduction control for stream data obtained by encoding image data is carried out, a DRM (Digital Rights Management) rule description in which content of the reproduction control is described as a rule of DRM; and

an addition portion configured to add the DRM rule description produced by the production portion to the stream data.

(13) The image processing apparatus according to (12), in which the content of the reproduction control contains prohibition of skip reproduction and prohibition period specification, specification of a period for which reproduction is required in advance, and prohibition of trick reproduction and prohibition period specification of the stream data.

(14) The image processing apparatus according to (12) or (13), in which the production portion produces a segment playback control information box in which the DRM rule description is stored and information regarding the reproduction control of the segment is stored.

(15) The image processing apparatus according to (14), in which the production portion produces a protection system specific header box in which the segment playback control information box is stored and information peculiar to the DRM is stored.

(16) The image processing apparatus according to any one of (12) to (15), further including:

a common description producing portion configured to produce a common description which exhibits the content of the reproduction control and which is of a type independent of the DRM; and

a common description adding portion configured to add the common description produced by the common description producing portion to an MPD (Media Presentation Description) as control information regarding reproduction of the stream data.

(17) The image processing apparatus according to (16), in which the content of the reproduction control contains prohibition of skip reproduction and prohibition period specification, specification of a period for which reproduction is required in advance, and prohibition of trick reproduction and prohibition period specification of the stream data.

(18) An image processing method, including:

producing, with respect to a segment with which reproduction control for stream data obtained by encoding image data is carried out, a DRM (Digital Rights Management) rule description in which content of the reproduction control is described as a rule of DRM; and

adding the DRM rule description thus produced to the stream data.

(19) An image processing apparatus, including:

an acquisition portion configured to acquire a DRM (Digital Rights Management) rule description which is added to stream data obtained by encoding image data and in which content of reproduction control is described as a rule of DRM;

a decoding portion configured to decode the stream data of an encrypted segment on the basis of the DRM rule description acquired by the acquisition portion; and

a reproduction control portion configured to control reproduction of the stream data of the segment decoded by the decoding portion.

(20) An image processing method, including:

acquiring a DRM (Digital Rights Management) rule description which is added to stream data obtained by encoding image data and in which content of reproduction control is described as a rule of DRM;

decoding the stream data of an encrypted segment on the basis of the DRM rule description acquired; and

controlling reproduction of the stream data of the segment decoded.

### REFERENCE SIGNS LIST

100 Content reproducing system, 101 Authoring device, 102 Content server, 103 Intermediate server, 104 Reproduction client, 105 DRM server, 111 Database, 121 Media segment, 122 MPD, 123 Synthetic MPD, 131 Content, 151 Media segment producing portion, 152 MPD producing portion, 161 Rule inputting portion, 162 DASH format data producing portion, 163 MAC value producing portion, 164 Event message data producing portion, 165 Event message data adding portion, 166 DRM rule description producing portion, 167 DRM rule description adding portion, 168 Media segment presenting portion, 261 Rule inputting portion, 262 DASH format data producing portion, 263 Common description producing portion, 264 Common description adding portion, 265 DRM rule converting portion, 266 DRM peculiar description producing portion, 267 DRM peculiar description adding portion, 268 MPD presenting portion, 411 Application portion, 412 DASH client portion, 413 Reproduction control portion, 414 MAC value storing portion, 415 DRM processing portion, 416 Media reproducing portion

1. An image processing apparatus, comprising:
a verification code producing portion configured to produce, with respect to a segment with which reproduction control for stream data obtained by encoding image data is carried out, a verification code of the stream data of the segment; and
a verification code adding portion configured to add the verification code produced by the verification code producing portion to the stream data.

2. The image processing apparatus according to claim 1, wherein the verification code producing portion produces a hash value for the stream data of the segment before being encrypted by using key information used in encryption or decoding of the stream data of the segment, and makes the hash value thus produced the verification code.

3. The image processing apparatus according to claim 1, further comprising:
an event message box producing portion configured to produce an event message box in which an event message is stored, and store the verification code produced by the verification code producing portion in the event message box thus produced,
wherein the verification code adding portion adds the event message box which is produced by the event message box producing portion and in which the verification code is stored to the stream data.

4. The image processing apparatus according to claim 3, wherein the event message box producing portion further stores a DRM (Digital Rights Management) rule description in which content of the reproduction control is described as a rule of DRM in the event message box.

5. The image processing apparatus according to claim 1, further comprising:
a DRM (Digital Rights Management) rule description producing portion configured to produce a DRM rule description in which content of the reproduction control is described as a rule of DRM; and
a DRM rule description adding portion configured to add the DRM rule description produced by the producing portion to the stream data.

6. The image processing apparatus according to claim 5, wherein the content of the reproduction control contains prohibition of skip reproduction and prohibition period specification, specification of a period for which reproduction is required in advance, prohibition of trick reproduction and prohibition period specification, prohibition of jump-in reproduction, prohibition period specification, and reproduction start position specification of the stream data.

7. The image processing apparatus according to claim 1, further comprising:
a common description producing portion configured to produce a common description which is of a type independent of DRM (Digital Rights Management) exhibiting content of the reproduction control; and
a common description adding portion configured to add the common description produced by the common description producing portion to an MPD (Media Presentation Description) as control information regarding the reproduction of the stream data.

8. The image processing apparatus according to claim 7, wherein the content of the reproduction control contains prohibition of skip reproduction and prohibition period specification, specification of a period for which reproduction is required in advance, and prohibition of trick reproduction and prohibition period specification of the stream data.

9. An image processing method, comprising:
producing, with respect to a segment with which reproduction control for stream data obtained by encoding image data is carried out, a verification code of the stream data of the segment; and
adding the verification code produced to the stream data.

10. An image processing apparatus, comprising:
a production portion configured to produce, with respect to a segment with which reproduction control for stream data obtained by encoding image data is carried out, a verification code of the stream data of the segment;
a comparison portion configured to compare the verification code produced by the production portion and a verification code added to the stream data with each other; and
a reproduction control portion configured to control the reproduction of the stream data of the segment, a following segment, or both of them in response to agreement or disagreement between the verification codes in the comparison by the comparison portion.

11. An image processing method, comprising:
producing, with respect to a segment with which reproduction control for stream data obtained by encoding image data is carried out, a verification code of the stream data of the segment;
comparing the verification code thus produced and a verification code added to the stream data with each other; and
controlling the reproduction of the stream data of the segment, a following segment, or both of them in response to agreement or disagreement between the verification codes.

12. An image processing apparatus, comprising:
a production portion configured to produce, with respect to a segment with which reproduction control for stream data obtained by encoding image data is carried out, a DRM (Digital Rights Management) rule description in which content of the reproduction control is described as a rule of DRM; and
an addition portion configured to add the DRM rule description produced by the production portion to the stream data.

13. The image processing apparatus according to claim 12, wherein the content of the reproduction control contains prohibition of skip reproduction and prohibition period specification, specification of a period for which reproduction is required in advance, and prohibition of trick reproduction and prohibition period specification of the stream data.

14. The image processing apparatus according to claim 12, wherein the production portion produces a segment playback control information box in which the DRM rule description is stored and information regarding the reproduction control of the segment is stored.

15. The image processing apparatus according to claim 14, wherein the production portion produces a protection system specific header box in which the segment playback control information box is stored and information peculiar to the DRM is stored.

16. The image processing apparatus according to claim 12, further comprising:
a common description producing portion configured to produce a common description which exhibits the content of the reproduction control, and which is of a type independent of the DRM; and
a common description adding portion configured to add the common description produced by the common description producing portion to an MPD (Media Presentation Description) as control information regarding reproduction of the stream data.

17. The image processing apparatus according to claim 16, wherein the content of the reproduction control contains prohibition of skip reproduction and prohibition period specification, specification of a period for which reproduction is required in advance, and prohibition of trick reproduction and prohibition period specification of the stream data.

18. An image processing method, comprising:
producing, with respect to a segment with which reproduction control for stream data obtained by encoding image data is carried out, a DRM (Digital Rights Management) rule description in which content of the reproduction control is described as a rule of DRM; and
adding the DRM rule description thus produced to the stream data.

19. An image processing apparatus, comprising:
an acquisition portion configured to acquire a DRM (Digital Rights Management) rule description which is added to stream data obtained by encoding image data and in which content of reproduction control is described as a rule of DRM;
a decoding portion configured to decode the stream data of an encrypted segment on the basis of the DRM rule description acquired by the acquisition portion; and
a reproduction control portion configured to control reproduction of the stream data of the segment decoded by the decoding portion.

20. An image processing method, comprising:
acquiring a DRM (Digital Rights Management) rule description which is added to stream data obtained by encoding image data and in which content of reproduction control is described as a rule of DRM;
decoding the stream data of an encrypted segment on the basis of the DRM rule description acquired; and
controlling reproduction of the stream data of the segment decoded.
